(19) United States
(12) Patent Application Publication
(10) Pub. No.: US 2025/0315743 A1
(43) Pub. Date: Oct. 9, 2025

(54) CORRELATING IMAGE AND WIRELESS LOCATION SIGNALS TO ESTIMATE WAIT TIMES

(71) Applicant: Target Brands, Inc., Minneapolis, MN (US)

(72) Inventors: David Kovacs, Lakeville, MN (US); Nicholas Lojewski, Minneapolis, MN (US); Yueming Liu, Minneapolis, MN (US)

(21) Appl. No.: 18/626,481

(22) Filed: Apr. 4, 2024

(51) Int. Cl. G06Q 10/04; G06V 10/764; G06V 10/80

(52) U.S. Cl. CPC G06Q 10/04; G06V 10/764; G06V 10/80

(57) ABSTRACT

Disclosed is technology for determining a wait time of objects in a designated area of a physical space. A system can include: cameras positioned proximate the designated area to capture image data of the designated area, location signaling devices to capture wireless signals indicating locations of the objects, the locations being provided as location data, and a computer system. The computer system can: receive the image data and the location data, translate the receive image data into a predetermined coordinate plane, retrieve one or more artificial intelligence (AI) models from a data store, identify the objects within the designated area based on applying the AI models to at least the translated image data, correlate the identified objects with the received location data, and determine wait time information of the identified objects in the designated area based on applying the AI models to at least the correlated data.

### TECHNICAL FIELD

This disclosure generally describes devices, systems, and methods related to combining different types of signals, such as image signals and wireless location signals, to determine and estimate guest wait times, such as in a store or other retail environment.

### BACKGROUND

Asset tracking, which may be performed in a variety of industries, can include tracking an asset's location throughout an environment. Asset tracking may be performed for a variety of objectives. Some example objectives may include gaining business insights, maximizing operational efficiencies, and/or avoiding asset loss and/or theft. Asset tracking in a retail environment may include collecting location information associated with a shopping trip at the retail environment. Such location information may be obtained by sensors that generate generalized location information, and may not track a detailed path of movement of the asset(s) or other relevant information about activities in the retail environment.

### SUMMARY

The disclosure generally describes technology for combining and correlating various signals, including but not limited to computer vision or image data and wireless location data, from different location technologies and devices throughout an environment (e.g., retail environment, store) to determine and/or estimate wait times in that environment. The disclosed technology can leverage artificial intelligence (AI) and other machine learning techniques to estimate or predict how long guests are waiting or may be expected to wait in a checkout area based on processing the correlated signals. The disclosed technology can use quantitative measures to gain insights into guest wait times and identify opportunities for improvement in the environment. For example, computer vision techniques and AI can be used to track guest wait times in a checkout area of a retail environment. Geometry and movement patterns can be used to determine whether a wait in line has occurred near the checkout area. The disclosed technology can also provide for visualizing the signals/data that is combined/correlated for daily wait time statistics, thereby enabling identification of patterns, peak hours, and areas for improvement over current and/or future periods of time.

The signals can be received from overhead lights in the environment, cameras and other imaging systems, various sensor devices, BLUETOOTH or other wireless location asset tags on baskets, carts, and other items, other wireless-connecting devices, such as mobile devices of the guests in the environment, LIDAR sensors, LoRa sensors, and/or RFID sensors. Any of these signals, and in particular image data (e.g., vision) and wireless location data (e.g., BLUETOOTH, ultra wideband, WIFI), can be correlated and combined to robustify guest trip activity information and determine guest wait times in the environment. Sometimes, any of the data, whether combined or alone, can further be associated with point of sale (POS), register, and/or other transactional data to improve accuracy in determining the guest trip activity information and the guest wait times. In some environments that may not have technologies that generate image or wireless location data, machine learning models can also be deployed to infer guest wait times using available POS/register behavior data.

More particularly, the disclosed technology can leverage computer vision techniques to identify, from the combined/correlated signals, geometry and movement patterns indicative of lines of guests forming near/in a checkout area of the environment. This technology may also trigger a timer, based on detecting, from the combined/correlated signals, that a guest has slowed down in speed in a particular identified zone before a checkout lane. The timer can run until the guest is detected to be entering a zone that is identified for the checkout lane. Once in the checkout lane, the timer may stop, thereby providing a measure of the guest's overall wait time before beginning a checkout process. Machine learning models and/or AI techniques can be applied to the combined signals to project or otherwise estimate future wait times at the environment or other environments.

One or more embodiments described herein can include a system for determining a wait time of objects in a designated area of a physical space, the system including: cameras that can be positioned proximate the designated area and that can be configured to capture image data of the designated area, location signaling devices that can be configured to capture wireless signals indicating locations of the objects throughout the physical space, the locations being provided as location data, and a computer system in wireless network communication with the cameras and the location signaling devices. The computer system can be configured to perform operations that may include: receiving the image data and the location data from the cameras and the location signaling devices, respectively, translating the receive image data into a predetermined coordinate plane, retrieving one or more artificial intelligence (AI) models from a data store, identifying the objects within the designated area based on applying the AI models to at least the translated image data, correlating the identified objects with the received location data, determining wait time information of the identified objects in the designated area based on applying the AI models to at least the correlated data, and returning the wait time information.

In some implementations, the embodiments described herein can optionally include one or more of the following features. For example, the predetermined coordinate plane can be a coordinate plane of the location data. Correlating the identified objects with the received location data can include verifying that the identified objects may be located within the designated area before moving to a second designated area proximate the designated area. Determining wait time information in the designated area may include generating a count of the identified objects that may form a line in the designated space.

As another example, determining wait time information in the designated area based on applying the AI models to at least the correlated data can include: determining that an object amongst the identified objects enters the designated area, detecting a decrease in movement of the object in the designated area, starting a timer in response to detecting the decrease in movement, determining that the object enters a second designated area proximate the designated area, stopping the timer in response to determining that the object enters the second designated area, and determining a wait time of the object as a total time that the timer was activated. The AI models could have been trained to perform the determining, the detecting, the starting, the determining, the stopping, and the determination operations. The AI models could have been trained to perform the determining the wait time of the object operation.

In some implementations, determining wait time information in the designated area may include: determining a wait time for each of the identified objects based on applying the AI models to at least the correlated data and determining an average wait time for the identified objects based on combining the wait time for each of the identified objects. Sometimes, identifying the objects within the designated area can include: identifying one or more objects that may be within a threshold proximity of each other in the designated area, and grouping the identified one or more objects into a group, where determining wait time information in the designated area can include determining a wait time for the group. The operations may also include: receiving transaction data from one or more point of sale (POS) terminals that may be proximate the designated area, and correlating, based on applying the AI models, at least one of the image data or the location data with the transaction data to determine the wait time information. Identifying the objects within the designated area based on applying the AI models to at least the translated image data further can include: detecting one or more of the objects that may satisfy one or more object behavior, and removing the detected objects from the translated image data. The operations can also include correlating portions of the translated image data with the received location data that may satisfy one or more proximity criteria, and identifying the objects within the designated area based on applying the AI models to the correlated data.

In some implementations, the identified objects can include assets, each of the assets having an asset signaling device. The asset signaling device can be configured to transmit and receive signals with at least the location signaling devices. The location signaling devices can be configured to generate the location data based on the transmitted and received signals with the asset signaling device. Sometimes, returning the wait time information can include presenting the wait time information in a graphical user interface (GUI) display of a user relevant to the physical space. The wait time information can be determined, by the computer system, for a predetermined future period of time. The AI models can include an ordinary least squares (OLS) model. Determining wait time information further may include generating a graphical depiction of the wait time information that can be synced with the translated image data. The designated area can be a wait area before a checkout area in a retail environment.

One or more embodiments described herein can include a method for determining a wait time of objects in a designated area of a physical space, the method including: receiving, by a computer system, (i) image data from cameras positioned proximate the designated area that can be configured to capture the image data of the designated area and (ii) location data from location signaling devices that can be configured to capture wireless signals indicating locations of the objects in the physical space, the locations being provided as the location data, translating, by the computer system, the received image data into a predetermined coordinate plane, retrieving, by the computer system, one or more artificial intelligence (AI) models from a data store, identifying, by the computer system, the objects within the designated area based on applying the AI models to at least the translated image data, correlating, by the computer system, the identified objects with the received location data, determining, by the computer system, wait time information of the identified objects in the designated area based on applying the AI models to at least the correlated data, and returning, by the computer system, the wait time information.

The method can optionally include one or more of the abovementioned features. The method can optionally include one or more of the following features. For example, determining, by the computer system, wait time information in the designated area may include: determining that an object amongst the identified objects enters the designated area, detecting a decrease in movement of the object in the designated area, starting a timer in response to detecting the decrease in movement, determining that the object enters a second designated area proximate the designated area, stopping the timer in response to determining that the object enters the second designated area, and determining a wait time of the object as a total time that the timer was activated.

The devices, system, and techniques described herein may provide one or more of the following advantages. For example, the disclosed technology provides lightweight processing and correlation of data sources to accurately identify activities in physical spaces such as retail environments or stores. The disclosed technology can be used to determine in real-time, or near real-time, current, expected, and/or future wait times around checkout areas in the retail environments. The disclosed technology can be used to model and understand overall activity in the retail environments, including but not limited to guest sentiment and interactions with promotions, advertisements, signage, and/or items/products more generally.

As another example, determining and projecting wait times can improve overall guest experiences in environments such as retail environments or stores. The disclosed technology may also be applied to various use cases to: improve tracking of assets and guest experiences within the environment, notify guests of how long they may wait to checkout, provide alerts to team members to open more checkout lanes, and/or notify additional team members to assist guests in a checkout area of the environment. This technology may also provide holistic views into overall guest wait times, which can be used by relevant users to improve wait times in the future in the particular environment and/or across multiple environments.

The details of one or more implementations are set forth in the accompanying drawings and the description below. Other features and advantages will be apparent from the description and drawings, and from the claims.

### BRIEF DESCRIPTION OF THE DRAWINGS

FIG. 1A is a conceptual diagram of a system for determining guest wait time in an environment using image and wireless location data.

FIG. 1B is a conceptual diagram of streams of data that can be received from sensor devices in an environment, processed, and correlated with each other using the disclosed techniques.

FIG. 1C illustrates example image data that is processed using the disclosed techniques to generate a mapping of activity near a checkout area of a retail environment.

FIG. 2A is a conceptual diagram of a system for determining guest information in a designated zone of an environment based on validating image data with wireless location data.

FIG. 2B is a conceptual diagram of a system for determining guest information in a designated zone of an environment based on validating wireless location data with image data.

FIG. 2C is a conceptual diagram of a system for processing image data and wireless location data separately, then combining the data to determine guest information.

FIG. 3 is a conceptual diagram of a system for determining guest wait time near a checkout area of a retail environment.

FIG. 4A illustrates an example cart that can communicate wirelessly with an indoor wireless location signaling system to transmit and/or receive wireless location signals.

FIG. 4B illustrates an example basket that can communicate wirelessly with an indoor wireless location signaling system to transmit and/or receive wireless location signals.

FIG. 4C illustrates an example mobile device that can communicate wirelessly with an indoor wireless location signaling system to transmit and/or receive wireless location signals.

FIGS. 5A and 5B is a flowchart of a process for correlating different signals to determine guest wait time information in an environment.

FIG. 6 is a flowchart of a process for estimating guest wait time based on POS and/or register activity data.

FIG. 7 illustrates example image data that is processed using computer vision techniques to determine guest information near a checkout area of a retail environment.

FIG. 8 illustrates example image data that is processed using the disclosed techniques to determine busyness in a retail environment.

FIG. 9 is a diagram illustrating one or more system components that can be used to perform the disclosed techniques.

FIG. 10 is a schematic diagram that shows an example of a computing device and a mobile computing device.

In the present disclosure, like-numbered components of various embodiments generally have similar features when those components are of a similar nature and/or serve a similar purpose, unless otherwise noted or otherwise understood by a person skilled in the art.

### DETAILED DESCRIPTION OF ILLUSTRATIVE EMBODIMENTS

This disclosure generally relates to systems, methods, and technology for combining and correlating different signals, such as vision data (e.g., image data, video data) and wireless location data (e.g., BLUETOOTH signals, or other asset tracking data and tags), to accurately track guest and asset movements in various zones of an environment, such as a retail environment or a store. Computer vision techniques, AI, and/or machine learning models can further be used to accurately approximate current and/or future guest wait times in one or more environments and correlate wait time with register behavior/POS activities. For example, the disclosed technology can provide computer-vision based wait time tracking, by identifying geometry and movement patterns indicative of whether a wait in line has occurred (or is likely to occur). The disclosed technology can also visualize data for daily wait time statistics, enabling identification of patterns, peak hours, and/or areas for improvement or other data-driven decisions and environment optimization operations. The disclosed technology can provide insights into wait time patterns for any predetermined time interval (e.g., daily, weekly) that can impact guest experiences in the environment.

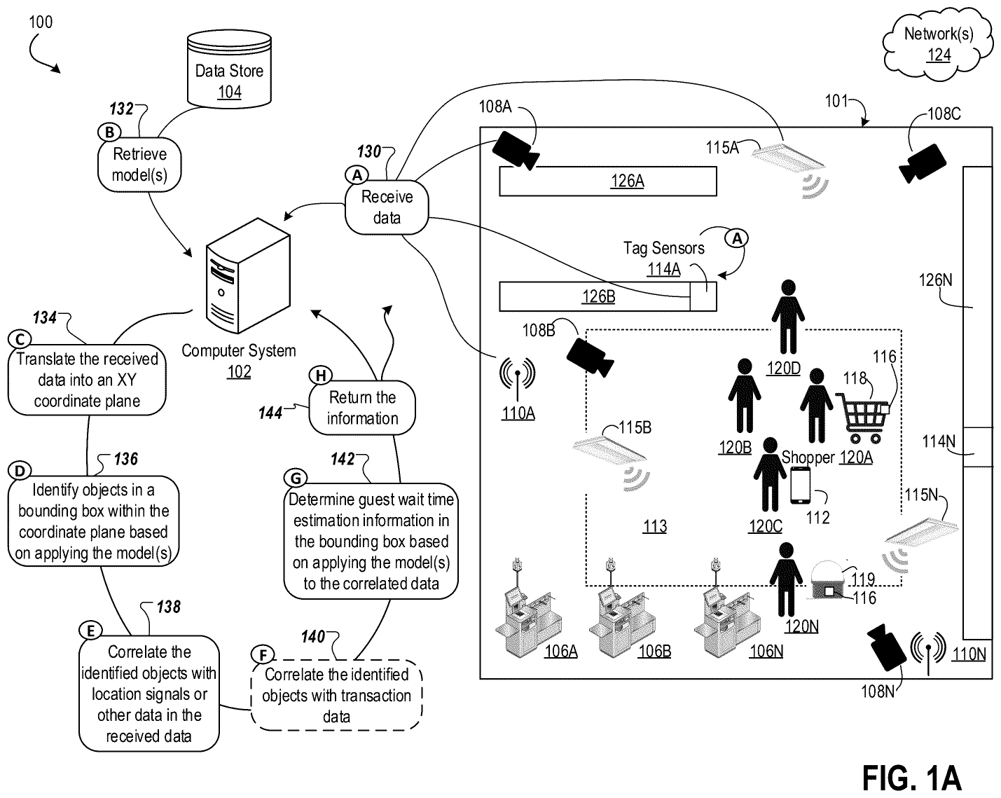

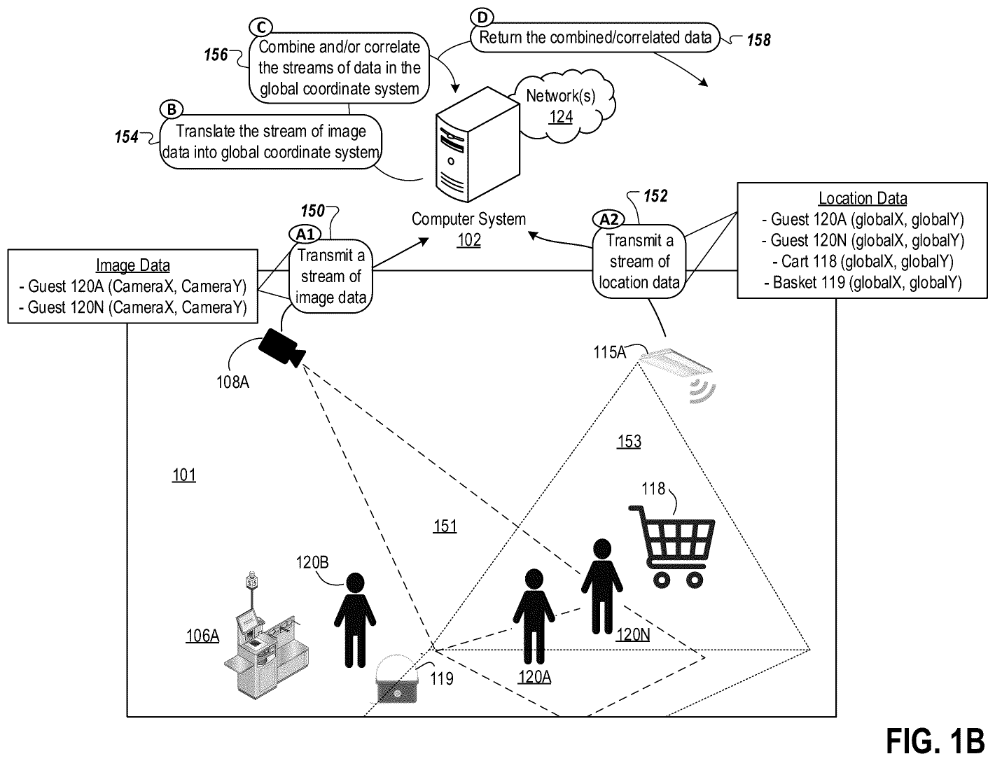

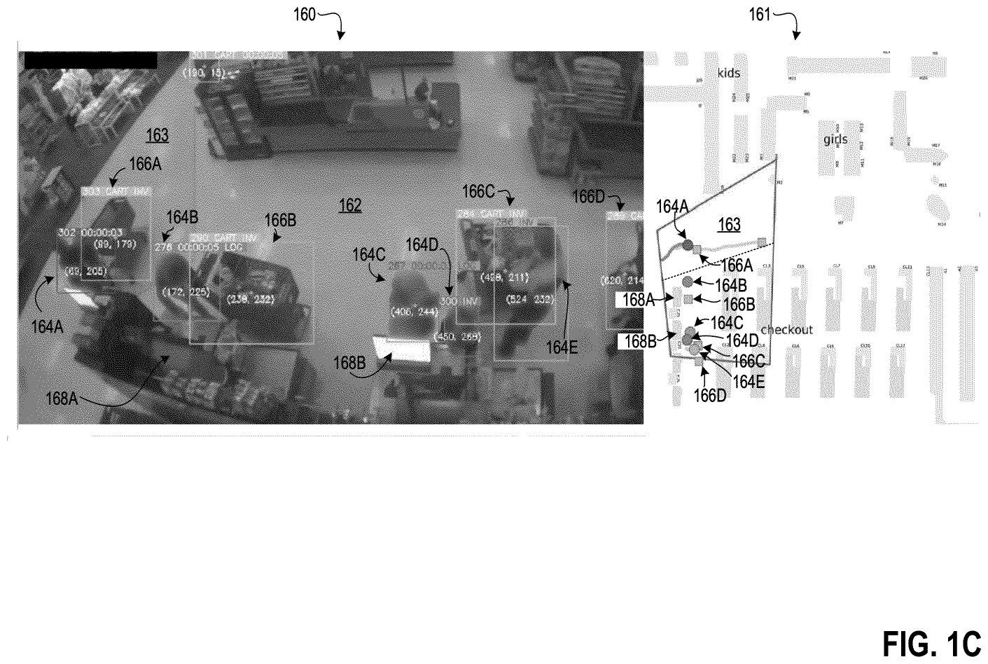

Referring to the figures, FIG. 1A is a conceptual diagram of a system 100 for determining guest wait time in an environment using image and wireless location data. As described herein, the environment can be a retail environment, such as a store 101. The store 101 can include shelves 126A-N throughout, which can hold items (e.g., products) that can be purchased by guests 120A-N. The store 101 can include various sensor devices, including but not limited to cameras 108A-N, wireless signaling devices 110A-N, tag sensors 114A-N, overhead sensors 115A-N(e.g., overhead lights, overhead nodes), and/or asset tags 116. Any of these sensor devices can generate signals/data that can be processed by a computer system 102 to glean insights about activity in the store 101, such as guest wait times in one or more designated areas of the store 101, such as a checkout area 113. The checkout area 113 can include checkout lanes, such as one or more POS terminals 106A-N. In some implementations, the checkout area 113 can encompass an area of the store 101 before the POS terminals 106A-N, where lines may form of the guests 120A-N waiting to purchase and checkout items they have selected from the shelves 126A-N.

In brief, the cameras 108A-N can include any type of imaging devices, computer vision devices, and/or security cameras that can be installed or previously installed in the store 101. The cameras 108A-N can be positioned throughout the store 101 to provide holistic image data of movement and activities throughout the store 101.

The wireless signaling devices 110A-N can include any types of beacons, signal transceivers, and/or signal receivers that can be positioned throughout the store 101. Such devices 110A-N can listen for, transmit, and/or receive different types of wireless signals, including but not limited to BLUETOOTH and/or WIFI. The devices 110A-N can be configured to communicate, via network(s) 124, with the asset tags 116 on assets in the store 101, such as carts 118 and/or baskets 119. The devices 110A-N can also be configured to communicate, via network(s) 124, with mobile devices 112 of one or more of the guests 120A-N in the store 101.

The tag sensors 114A-N can be devices configured to listen for, transmit, and/or receive RFID signals and/or asset tag signals from one or more objects in the store 101. The objects in the store 101 can include but are not limited to items that are available for purchase in the store 101, the carts 118, the baskets 119, and/or other movable fixtures.

The overhead sensors 115A-N can be configured to receive signal strengths and use that information to identify where objects are located in the store 101 and/or for how long. The sensors 115A-N can drive and produce location and corresponding time information, which can be used by the computer system 102 to determine information about activities in the store 101, such as guest wait time in the checkout area 113.

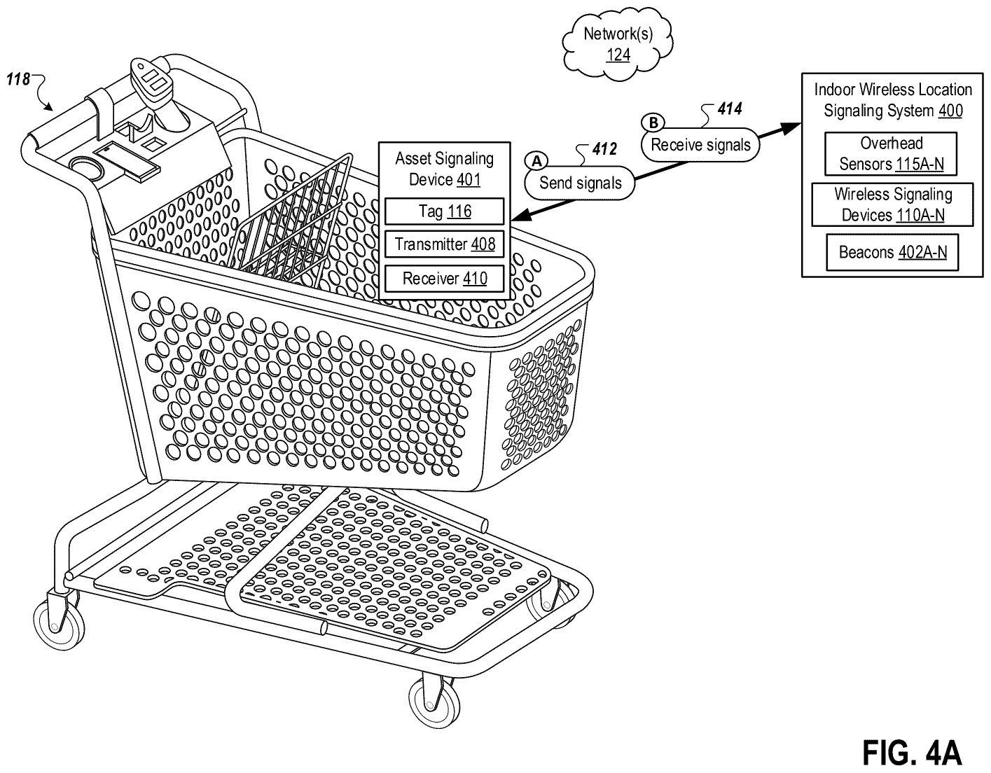

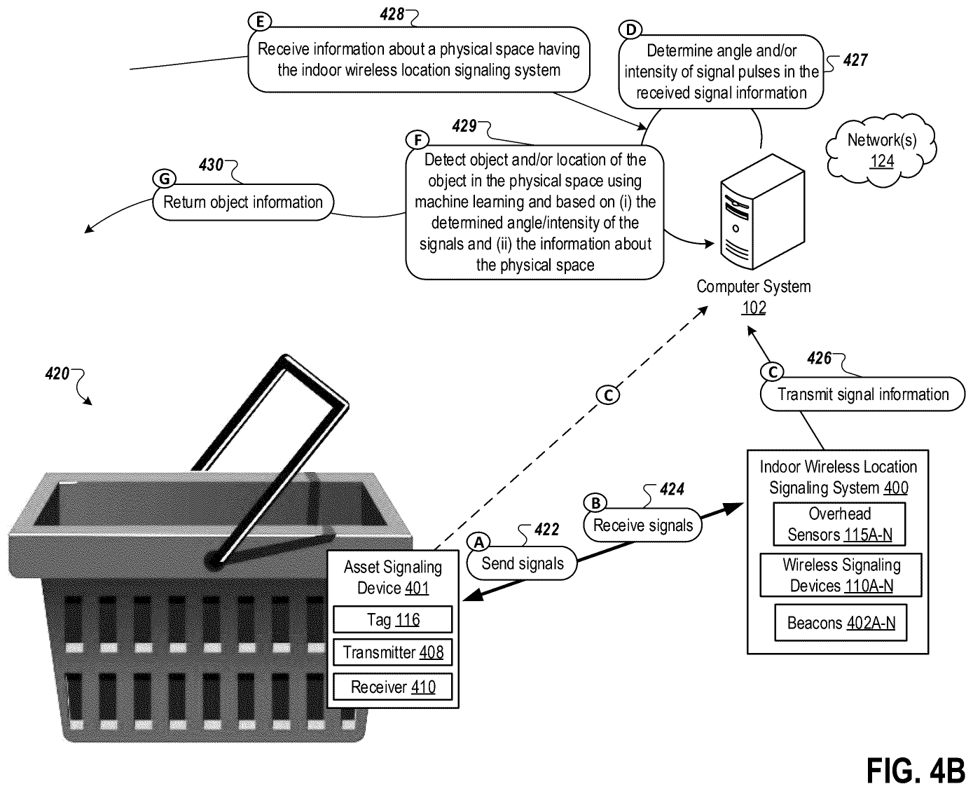

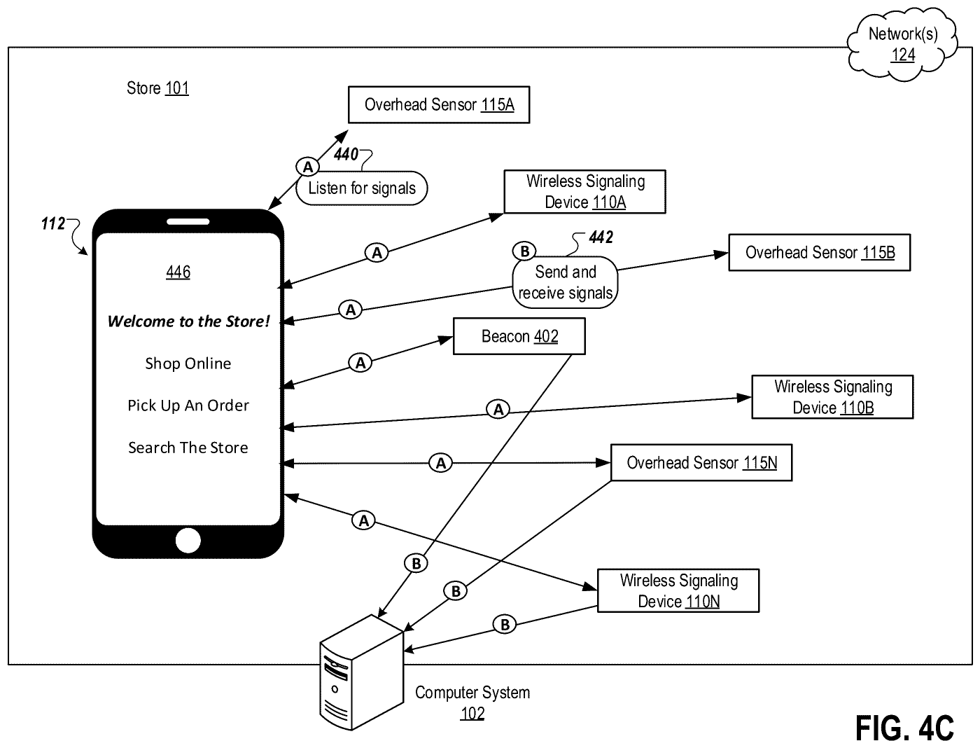

The asset tags 116 can be BLUETOOTH and/or RFID tags, which can be attached to assets in the store 101, such as the carts 118 and/or the baskets 119. The tags 116 can be configured to identify the carts 118 and/or the baskets 119 as they move throughout the store 101. The tags 116 can communicate with one or more other sensor devices in the store 101, such as the overhead sensors 115A-N, the tag sensors 114A-N, and/or the wireless signaling devices 110A-N. The asset tags 116 can sometimes include one or more wireless location signaling devices, as described further in reference to FIGS. 4A and 4B. The asset tags 116, in some implementations, can be electronic devices attached to the assets described herein and configured to receive and response to interrogation wireless signals (e.g., beacon signals). For example, the asset tags 116 may use BLUETOOTH Low Energy (BLE) technology, wireless Ethernet (WIFI) technology, RFID technology, visual light communication (VLC), long range (LoRa) technology, or other wireless communication technology to receive interrogation signals from one or more indoor wireless location signaling systems (refer to FIGS. 4A and 4B for further discussion) and to emit wireless signals that may carry information to be read by sensors and/or the indoor wireless location signaling systems described herein.

Still referring to the system 100 of FIG. 1A, the computer system 102 can communicate via the network(s) 124 (e.g., wired, wirelessly) with any of the sensor devices described above, the mobile devices 112 of the guests 120A-N, the POS terminals 106A-N, and/or a data store 104 in order to identify and/or determine insights/information about the store 101. Such insights can include, for example, actual and/or estimated/predicted wait times of the guests 120A-N in one or more designated areas, such as the checkout area 113, whether and/or when guest wait lines form, how many guests and/or groups of guests may be in the line(s), etc.

The computer system 102 can receive data (e.g., continuously, in batches, at predetermined time intervals) from one or more of the cameras 108A-N, the overhead sensors 115A-N, the tag sensors 114A-N, the wireless location devices 110A-N, the POS terminals 106A-N, the asset tags 116, and/or the mobile devices 112 of the guests 120A-N(block A, 130). The data can include image or vision data from the cameras 108A-N. The data can include location data, wireless signals, BLUETOOTH signals, etc. from the overhead sensors 115A-N, the tag sensors 114A-N, the wireless location devices 110A-N, the asset tags 116, and/or the mobile devices 112. The data can include transaction data (e.g., transaction times, items purchased in a transaction, POS identification data, throughput data) from the POS terminals 106A-N.

The computer system 102 can also retrieve one or more models from the data store 104 in block B, 132. The model(s) can be any type of machine learning and/or AI models described herein. The model(s) can be used to correlate the various types of data received from the sensor devices in block A (130). The model(s) can also be used to glean insights about operations in the store 101, such as identifying and determining information about a wait time and/or line for the guests 120A-N in the checkout area 113.

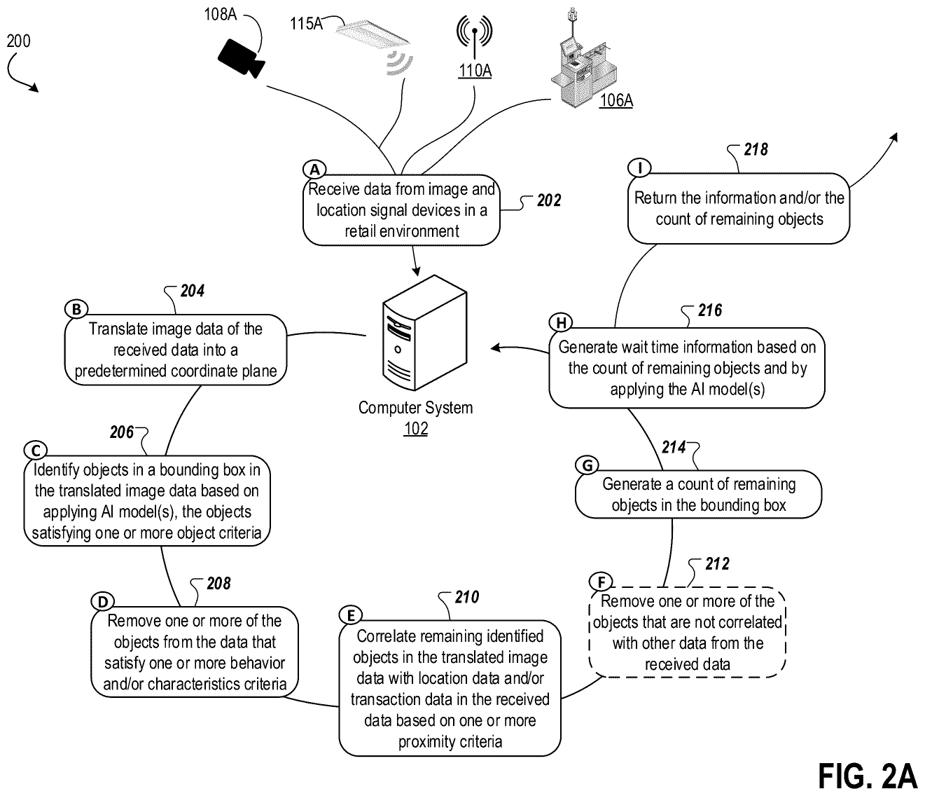

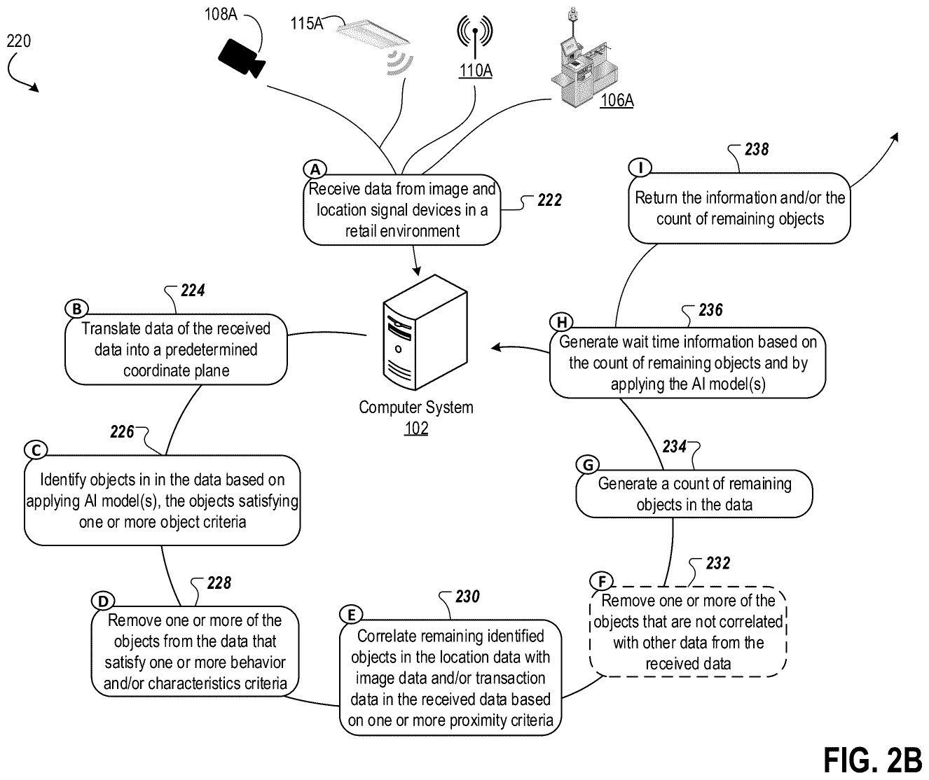

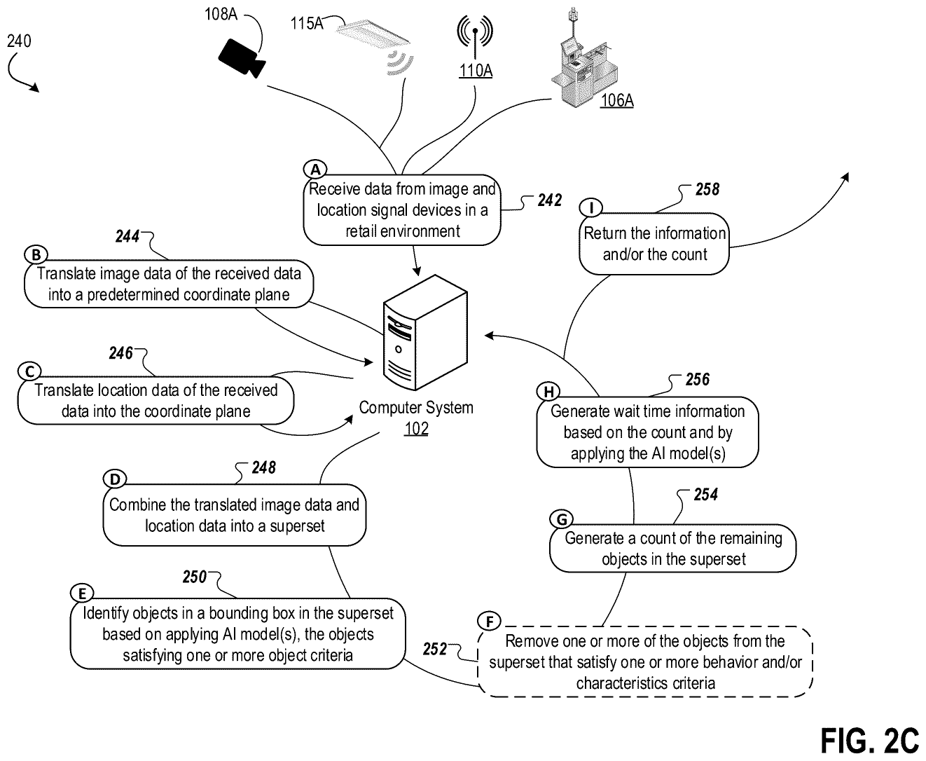

In block C, 134, the computer system 102 can translate the received data into an XY coordinate plane. For example, and as described further in reference to at least FIGS. 1B and 2A, the computer system 102 can translate image data from the cameras 108A-N into a predetermined coordinate plane, such as a coordinate plane of the overhead sensors 115A-N. The image data can be translated to points on a mapping of the physical space using homography and lens dewarping techniques. For example, the computer system 102 can compute a homography matrix for each angle/field of view of each of the cameras 108A-N. To generate the homography matrix, the computer system 102 can receive at least 3 points in common between an image (or pixel) view and the desired coordinate plane, then correlate positions from more than one independent data field based on timestamps. The computer system 102 can also dewarp the image data (e.g., video feed) from the cameras 108A-N to remove any lens artifacts and/or curving. Next, the computer system 102 can pass X, Y locations of each object in the dewarped image data (e.g., each frame of the video feed) through the homography matrix to obtain corresponding X, Y coordinates on the mapping of the physical space.

The computer system 102 can identify objects in a bounding box within the coordinate plane based on applying the model(s) (block D, 136). The bounding box can correspond to the checkout area 113. The model(s) can be trained to identify each object within the bounding box, then designate a bounding box around the identified object. The identified object, in its respective bounding box, can then be tracked as it moves or is moved throughout the store 101, including but not limited to the bounding box of the checkout area 113.

Moreover, the applied model(s) can be a computer vision detection model that can be trained on ground truth data from the cameras 108A-N. The ground truth data can be annotated (e.g., by relevant users, automatically by the computer system 102) and can be used to train a neural network that can identify and differentiate pedestrians, carts, handbaskets, and/or other types of assets that may appear in the physical space. Once the model is trained and accuracy of the model is satisfactory (e.g., achieves a predetermined threshold level of accuracy), the model can be used for object identification in the image data (e.g., video feeds).

One or more rules for identifying the objects can be applied with the model(s) in block D (136). For example, the computer system 102 can apply rules with the model that causes identification of the guests 120A-N versus team members or employees in the store 101. The model can be trained to detect a guest from a team member based on types of movements and/or time spend in the checkout area 113 and/or proximate the POS terminals 106A-N. For example, the model can be trained to identify a team member as an object that moves slightly within the checkout area 113 and remains within the checkout area 113 for a period of time that exceeds some threshold period of time (such as a period of time associated with how long an average guest may wait in line and/or perform a checkout process at the particular store 101). As another example, the computer system 102 can apply rules that causes identification of individual guests versus groups of guests that are shopping together (e.g., as a family, as a unit). For example, the model can be trained to identify distances between identified guests. If a distance between two guests is less than some predetermined threshold distance, then the model can generate output indicating that the two guests are likely together and count as one shopping unit, rather than two separate guests on a wait line.

The computer system 102 and/or the model(s) can leverage computer vision techniques to identify objects, such as the guests 120A-N, the carts 118, and/or the baskets 119 as they move throughout the store 101. For example, the computer vision techniques can be used to identify, from image data captured by the cameras 108B and 108N, when the guests 120A, 120B, 120C, and 120D enter the checkout area 113 and/or when the guest 120N exits the checkout area 113 to begin a checkout process at the POS terminal 106N. Such computer vision techniques and modeling may also be used to start and stop a timer to determine how long each of the guests 120A-N (and/or their corresponding assets such as the carts 118, the baskets 119, and/or the mobile devices 112) remain within the checkout area 113 before approaching one of the POS terminals 106A-N. Additionally or alternatively, the disclosed computer vision techniques and/or modeling can be used to determine how many spots exist in a wait line in the checkout area 113, which can be verified and/or made more accurate by correlating the image data with other data that is received in block A (130), such as location and/or wireless signaling data from the overhead sensors 115A-N.

The computer system 102 can correlate the identified objects with location signals or other data (e.g., wireless location signals) in the received data in block E (138). Timing information associated with the data can be used to correlate the data and identify the data having overlapping field of views (FOVs). The correlation can be achieved using the trained model(s). The location signals can provide for identification of objects throughout the entire store 101, however standing on its own, such signals may provide less granularity about complete activity of those objects. Therefore, the location signals can be used to robustify other data, such as the image data, about the objects by using the correlation techniques described herein. To correlate the location signals with the image data, for example, the computer system 102 can align their timings and identify their proximity in space. The image data can be used as a baseline, then the computer system 102 can identify location signals that coincide with the timing of the image data. If a significant portion of location signal pings align, the computer system 102 can select a path from the location signals data that best matches the image data. This process can further be enhanced as multi-camera inputs are used to re-identify a same object between different camera fields of view.

Because the cameras 108A-N have fixed vantage points (refer to FIG. 1B for further discussion), the computer system 102 can correlate image data from the cameras 108A-N with location data of the other sensor devices in the store 101, such as the overhead sensors 115A-N to generate a robust understanding of activities in the store 101 (such as a line forming in the checkout area 113). For example, the computer system 102 may automatically correlate movements across the cameras 108A-N to identify locations of objects moving throughout the store 101, then correlate those movements with the location data from devices such as the overhead sensors 115A-N. The computer system 102 may utilize re-detection computing techniques to form complete paths (or as complete as possible) of object movement from simply the image data. The computer system 102 may also leverage tag location inputs to fill in gaps in areas of the store 101 where there may not be camera coverage.

Correlating the image data with the location and/or time data can further be used to more accurately determine whether a line of the guests 120A-N has formed in the checkout area 113 and/or how long the line may be. Correlating the image data with the location and/or time data can further be used to accurately determine when items available for purchase, the guests 120A-N, the baskets 119, and/or the carts 118 are in particular locations and/or zones in the store 101, as well as for how long such objects remain in those locations.

Optionally, the computer system 102 may correlate the identified objects with transaction data received from the POS terminals 106A-N(block F, 140). The transaction data can be used to validate the correlated data for the identified objects. Sometimes, the transaction data can be used to robustify the correlated data, thereby creating a more robust understanding of activity of the identified objects.

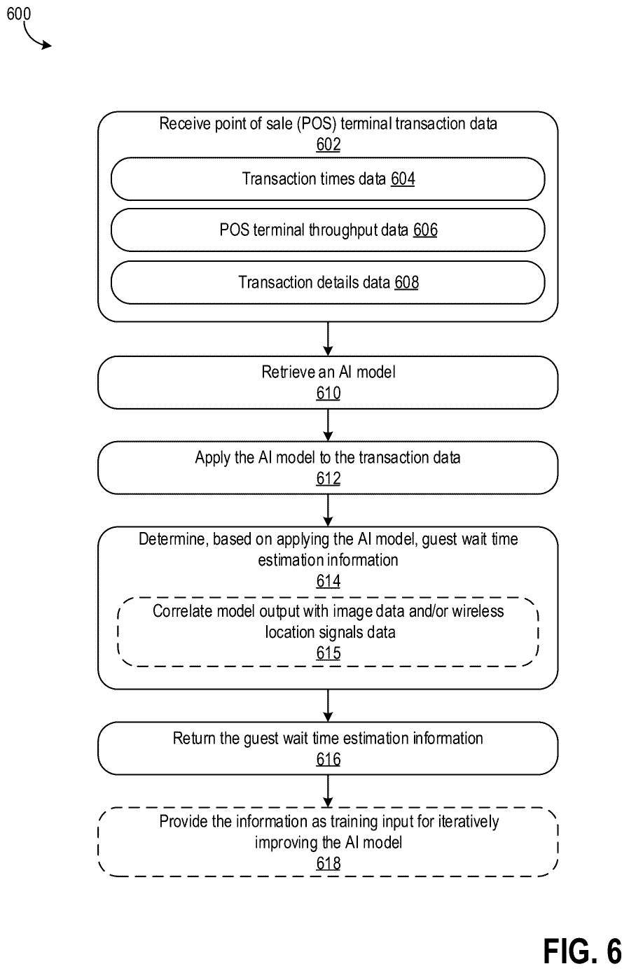

As described herein, the computer system 102 can process the image data first, then verify or robustify the image data with the location data. For example, the computer system 102 can utilize computer vision techniques to identify the guests 120A-N in the checkout area 113, and then validate such identification(s) with wireless location information from other sensor devices in the store 101 (e.g., location data from the overhead sensors 115A-N). As described in reference to FIGS. 2A, 2B, and 2C, sometimes the computer system 102 can process the location data first, then verify or otherwise robustify the location data with other received data, such as the image data from the cameras 108A-N. Sometimes, the computer system 102 can process the location data and the image data separately, then combine the processed data to generate a superset of data, which can be used to accurately glean insights about the store 101 (such as guest wait times). In yet some implementations, the computer system 102 may neither receive nor process location data or image data. Instead, the computer system 102 may receive only transaction data from the POS terminals 106A-N. The computer system 102 can apply the model(s) to the transaction data to glean insights about the store 101, such as the guest wait times. Refer to FIG. 6 for further discussion.

In block G (142), the computer system 102 can determine guest wait time estimation information in the bounding box based on applying the model(s) to the correlated data. The model(s) can be trained on historic and/or previous determinations of guest wait times. As a result of the training, the model(s) can determine whether there is a current wait line in the checkout area 113, whether the wait line is expected to get longer, how long a guest waits in the current line, how long the guest is expected to wait in the line over some predetermined period of time, and/or how many guests are currently in the line. When the image data is processed by the computer system 102 (e.g., using the models described herein), the computer system 102 can generate data such as outlining all motion or movements of identified guests, carts, baskets, and/or other assets. Motion data algorithms can be applied by the computer system 102 to determine what motions are representative of a guest waiting in line in the checkout area 113. One or more of the models described herein can be trained to determine the motions that represent guests waiting in line. As described herein, these motions have timestamps associated with them, which can be used, in combination with historic wait time data and estimations, by the computer system 102 and/or one or more models to determine current wait time information. The computer system 102 may also determine additional visual metrics in response to correlating the image data and the location data. The additional visual metrics can include, but are not limited to, object orientation, sentiment, product interactions, etc.

The computer system 102 can then return the information in block H (144). The information can be returned to a computing device of a relevant user, such as a team member or employee at the store 101. The information may also be returned to computing devices of management personnel and/or other users associated with the store 101 and/or a network of the stores 101. The returned information can be presented in graphical user interface (GUI) displays and used by the relevant users to identify guest waiting information in the checkout area 113. The relevant users can utilize this information to generate and/or update strategies to reduce overall wait times in the particular store 101 and/or the network of the stores 101. Sometimes, the information can be returned to and presented at the mobile devices 112 of the guests 120A-N. The guests 120A-N can view such information to determine how long of a wait they may have in the checkout area 113 of the store 101 and/or whether they should pursue alternative shopping methods, such as drive-up and/or in-store-pickup of items. Sometimes, the information can be returned to and presented at the computing device of a team member on the floor in the store 101. The information can be presented as a real-time or near real-time/proactive alert at the computing device, thereby notifying the team member to open up more checkout lanes in the checkout area 113. In yet some implementations, the information can be used by relevant users to anticipate when the guests 120A-N would arrive at the checkout area 113 and/or to identify acceptable criteria for determining what checkout lanes to send those guests to.

As shown in the example of FIG. 1, a line of the guests 120A, 120B, 120C, and 120D has formed in the checkout area 113. The guest 120N has left the checkout area 113 and is at the POS terminal 106N with their basket 119. The guest 120N is ready to or already engaging in a checkout process to purchase items held in their basket 119. The guest 120D is entering the checkout area 113. In the checkout area 113, the guest 120C is next in line to approach one of the POS terminals 106A-N to complete a checkout process. Here, the guest 120C has their mobile device 112. The guest 120C may also be holding one or more items in their hands as they wait in line. The guest 120A is waiting in line after the guest 120C with the shopping cart 118. The shopping cart 118 can include one or more items that the guest 120A wishes to purchase. The guest 120B may not be holding any items but can be standing next to the guest 120A. Using the techniques described herein, the computer system 102 can identify, from correlating image data from the cameras 108B and/or 108N with location data from at least the overhead sensors 115B and 115N and the asset tag 116, that the guest 120B is within a predetermined distance from the guest 120A that indicates the guests 120A and 120B are likely shopping together. Therefore, the computer system 102 can identify the guests 120A and 120B as a unit in the line that is formed in the checkout area 113, the line starting with the guest 120C. In the example of FIG. 1, the other POS terminals 106A and 106B may be closed or otherwise unavailable. In the store 101, any quantity of the POS terminals 106A-N can be open and available for use. In some implementations, the POS terminals 106A-N can be part of self-checkout lanes. The POS terminals 106A-N can be part of checkout lanes manned by team members in the store 101. The POS terminals 106A-N can also be part of a combination of the self-checkout lanes and the checkout lanes manned by the team members. The layout of the checkout lanes can vary based on the store and/or available staff, busyness, and/or other resources.

Still referring to the example system 100 in FIG. 1A, the camera 108B can have a FOV that includes a portion of the checkout area 113. Sometimes, the camera 108B can have a FOV that includes all of the checkout area 113, less than all of the checkout area 113, and/or other portions of the store 101 that include or do not include the checkout area 113. The camera 108N can have a FOV that includes a portion of the checkout area 113 and/or the POS terminals 106A-N. The overhead sensors 115B and 115N can have vantage points that include at least portions of the checkout area 113 and/or the POS terminals 106A-N. Any of the cameras 108B and 108N and the overhead sensors 115B and 115N can transmit signals they generate to the computer system 102. The computer system 102 can process the signals using the techniques described above to determine that the guests 120C, 120A, 120B, and 120D are in line in the checkout area 113. The computer system 102 can further determine that the line includes 3 parties (1 party being the guest 120C, 1 party being the guests 120A and 120B, and 1 party being the guest 120D). The computer system 102 can determine other guest wait time information described herein using the disclosed techniques.

FIG. 1B is a conceptual diagram of streams of data that can be received from sensor devices in an environment, processed, and correlated with each other using the disclosed techniques. In the example of FIG. 1B, the store 101 can include at least the camera 108A and the overhead sensors 115A. The camera 108A can have a FOV 151, which, in this example, may only include the guests 120A and 120N. The guest 120N's shopping cart 118 may not appear within the FOV 151 of the camera 108A. Similarly, the guest 120B and their basket 119 may be outside of the FOV 151, at the POS terminal 106A in the store 101.

The overhead sensor 115A can have a FOV 153, which may or may not overlap with the FOV 151 of the camera 108A. In this example, the FOV 153 can include the guests 120A and 120N and the shopping cart 118 of the guest 120N. The FOVs 151 and 153 can be different sizes and/or have different angles, which can vary based on placement and/or configuration of the camera 108A and the overhead sensor 115A in the store 101.

The camera 108A can transmit a stream of image data (block A1, 150) to the computer system 102. The image data can include, for example, images of the guest 120A and the guest 120N. Each of the image data can be in a coordinate plane associated with the angle and/or FOV 151 of the camera 108A. Each of the image data can include an identifier, such as an identifier for an object that is identified in the FOV 151 (e.g., the guest 120A and the guest 120N). Each of the image data may also include angle and/or position data of the identified object relative the FOV 151 of the camera 108A (e.g., the (CameraX, CameraY) coordinates).

The overhead sensor 115A can transmit a stream of location data (block A2, 152) to the computer system 102. The location data can include, for example, location and/or time data associated with the guest 120A, the guest 120N, the cart 118, and/or the basket 119. The stream of location data can be used by the computer system 102 to detect continuous movement of guests entering a checkout lane from a sales floor, exiting towards an entrance of the checkout lane, and/or intersecting with a checkout lane's centroid line. If these conditions are met/identified, then the computer system 102 can identify the guest's path as a guest checkout path. If the guest, for example, does not have a device with them (e.g., mobile phone, asset tag) as they are moving in the store 101, the computer system 102 may rely on the image data to determine and detect the guest's checkout path.

Each of the location data can be in a coordinate plane associated with the overhead sensor 115A. As an illustrative example, the coordinate plane of the overhead sensor 115A can be a global or other standard coordinate plane. Each of the location data can include an identifier for an object that is identified in the FOV 153 (e.g., the guest 120A, the guest 120N, the cart 118, the basket 119). Each of the location data can include position data of the identified object relative the FOV 153 of the overhead sensor 115A (e.g., the (globalX, globalY) coordinates). As shown, the image data and the location data may not be the same or similar, although they can be correlated with each other using the disclosed techniques to discern insights about activity in the store 101.

The computer system 102 can receive the streams of data from the camera 108A (in block A1, 150) and/or the overhead sensor 115A (in block A2, 152) at same, similar, or different times. The streams of data can be received continuously, as they are captured, in real-time, or in near real-time. The streams of data can be received in batches and/or at predetermined time intervals, in some implementations.

The computer system 102 can translate the stream of image data into a global coordinate system corresponding to the location data from the overhead sensor 115A (block B, 154). In other words, the computer system 102 can convert the camera coordinates for each of the image data into corresponding global coordinates. As described above, the computer system 102 can implement homography and lens dewarping techniques to convert the camera coordinates to the global coordinates.

Once the image data is converted to the global coordinate system, the computer system 102 can combine and/or correlate the streams of data in the global coordinate system, as described herein (block C, 156). The computer system 102 can use one or more AI models and/or machine learning techniques to combine and/or correlate the streams of data. Combining and/or correlating the data can include measuring proximity between different data points, and if the proximity is within some threshold value or range, the computer system 102 can correlate those data points with each other. The data points can be correlated to illustrate associations between guests in the store 101 and activities and/or objects therein.

The computer system 102 can then return the combined and/or correlated data for further processing in block D (158). The further processing can include determining and generating guest wait time estimation information, as described herein.

FIG. 1C illustrates example image data 160 that is processed using the disclosed techniques to generate a mapping 161 of activity near a checkout area 162 of a retail environment. As described herein, computer vision techniques can be leveraged as a source of validation and/or truth dataset for insights about guest activity and other activity in the retail environment. Homography data, for example, can enable various insights into guest activity. Such data can be processed with computer vision techniques, AI models, and/or machine learning techniques to analyze guest interaction with specific displays, fixtures, items, etc. Moreover, the disclosed technology can also utilize heatmaps to identify high activity areas, such as identifying congestion in a wait area 163 near the checkout area 162. Furthermore, the disclosed technology can be used to optimize the mapping 161 (e.g., layout) of the retail environment in an effort to reduce potential congestion.

The computer system 102 described herein can receive the image data 160 and process the image data using object detection techniques. The computer system 102 can generate a bounding box for each identified object in the image data 160. Here, the computer system 102 can generate a bounding box 166A for a cart that is identified in the wait area 163 along with a bounding box 164A for a guest that is identified in the wait area 163 with the cart. The computer system 102 can also generate a bounding box 166B for a cart that is identified in the checkout area 162 along with a bounding box 164B for a guest that is identified in the checkout area 162 at a checkout lane 168A. The computer system 102 can generate a bounding box 166C for another cart that is identified in the checkout area 162 along with bounding boxes 164C, 164D, and 164E for guests that are identified in the checkout area 162 with the another cart at a checkout lane 168B. Moreover, the computer system 102 can generate a bounding box 166D for a cart that is partially identified in the checkout area 162 within the FOV of the camera capturing the image data 160. As shown in FIG. 1C, the bounding boxes 164A-E and 166A-D can then be plotted onto the mapping 161 of the retail environment to provide visibility of activities within the retail environment, and particularly within the wait area 163 and the checkout area 162.

FIG. 2A is a conceptual diagram of a system 200 for determining guest information in a designated zone of an environment, such as a store, based on validating image data with wireless location data. The system 200 can also be used as a subtractive method, to remove objects, or people, from consideration based on their behavior.

For example, the computer system 102 described herein can detect 2 people in a checkout area, near a POS terminal. Using object detection techniques, computer vision techniques, AI modeling, or any combination thereof, the computer system 102 can determine that 1 person is a guest and 1 person is a team member working in the store. The guest may be performing movements that the computer system 102 (e.g., the model) recognizes as typical guest movements, such as moving items from a cart or basket onto a flatbed, scanning the items, moving the items across the flatbed and/or in front of the POS terminal, bagging the items, and providing a form of payment at the POS terminal. The team member may be performing movements that the computer system 102 recognizes as typical team member movements, such as walking back and forth in the checkout area, standing for extended periods of time in place in the checkout area, approaching different POS terminals for shortened periods of time, etc. Once the computer system 102 identifies the guest and the team member, the computer system 102 can extract the team member from the data and only consider the guest when generating information about the store, such as guest wait time information.

As another example of the subtractive method, the computer system 102 can validate the image data with the wireless location data to detect groups of guests as a unit, rather than individual guests waiting in the checkout area to complete their independent checkout processes. In the image data, the computer system 102 can identify 3 guests standing near each other in the checkout area and 1 cart. The wireless location data can indicate only 1 wireless signal that is within a threshold proximity/distance from the identified 3 guests in the checkout area. The computer system 102 can accordingly group the 3 guests together as a unit and match the cart to the unit of 3 guests. In terms of a guest wait, this unit of guests can count as 1 spot in a guest wait line (rather than 3 separate guests in line), thereby providing more accurate detection and estimation of guest wait time information in the store.

Referring to the system 200 in FIG. 2A, the computer system 102 can receive data from image and location signaling devices in a retail environment (e.g., store) in block A (202). Refer to FIGS. 1A and 1B for further discussion about image data and location data that can be received by the computer system 102. The signaling devices can include, as illustrative examples, the camera 108A, the overhead sensor 115A, the wireless signaling device 110A, and/or the POS terminal 106A. Refer to FIG. 1A for further discussion about the signaling devices.

The computer system 102 can translate image data (from the camera 108A) of the received data into a predetermined coordinate plane (block B, 204). The predetermined coordinate plane can be a coordinate plane of location data that is provided in the received data.

In block C (206), the computer system 102 can identify objects in a bounding box in the translated image data based on applying one or more AI models, the objects being identified based on satisfying one or more object criteria. The bounding box can be associated with a checkout area or an area proximate checkout lanes where guests can wait in line before proceeding to a checkout lane. The bounding box can also be associated with any other areas or regions in the retail environment. The one or more object criteria can be used to identify different types of objects appearing in the image data, including but not limited to guests, team members, carts, baskets, and/or items for purchase. Identifying the objects in block C (206) can also include generating a bounding box around each identified object so that such bounding box can be tracked over time within the bounding box associated with the checkout area.

The computer system 102 can also remove one or more of the identified objects from the data that satisfies one or more behavior and/or characteristics criteria (block D, 208). As described above, the computer system 102 can apply the AI model(s) to analyze the bounding box of each identified object and determine whether such bounding box corresponds to a guest or a team member. The one or more criteria can include rules indicating what types of behaviors, characteristics, and/or movements may be indicative of a guest versus a team member. For example, minimal movement, extended periods of time standing in place, and/or walking back and forth in the checkout area can be behaviors indicative of a team member. On the other hand, movements to move items along a flatbed at a checkout lane and/or provide payment to a POS terminal at the checkout lane can be behaviors indicative of a guest. Various other rules and/or criteria can be defined and used by the computer system 102 to determine which objects may be removed from the data in block D (208).

In some implementations, block D (208) can be performed as part of block C (206). Sometimes, the computer system 102 may simply identify only objects in block C (206) according to the one or more object criteria and the one or more behavior and/or characteristics criteria (thereby identifying only guests and assets, not team members). Therefore, the computer system 102 may not perform multiple steps of identifying all objects and then removing objects that are not of interest for further processing (team members).

The computer system 102 can correlate the remaining identified objects in the translated image data with the location data and/or transaction data in the received data, based on one or more proximity criteria (block E, 210). The proximity criteria can indicate spatial and/or time-related proximity. The computer system 102 can validate identification of the objects in the translated image data with the other received data, where the other received data can be overlapping with the translated image data (e.g., overlapping times, overlapping spatial proximity, overlapping FOVs). The correlation techniques in block E (210) can be performed using the AI model(s) described herein, where the AI model(s) can be trained to correlate the received data according to one or more rules and/or the proximity criteria.

As an illustrative example of correlating the data, the computer system 102 can identify a guest and a cart nearby the guest in the translated image data in the checkout area of the retail environment. The computer system 102 can identify, in the location data, an asset tag identifier for the cart at time A and location (1, 1). When the image data is translated to the coordinate plane of the location data, the computer system 102 can identify the cart object at a location approximate (1, 1) of the location data, such as (0.965, 1.1). The computer system 102 can determine that the cart in the location data corresponds to the identified cart in the translated image data, and thus correlate the data. The computer system 102 can further determine that the identified guest in the translated image data is most likely associated with the cart that appears in the translated image data and the location data based on the guest being identified within a predetermined threshold distance from the cart in the translated image data, the location data, or a combination thereof. Accordingly, the computer system 102 can correlate the translated image data of the guest with the location data of the cart. As another example, the computer system 102 can determine, from the translated image data, that the guest and the cart are most likely associated with each other. The computer system 102 can then analyze the other received data, such as the location data associated with the cart, to validate the association made between the guest and the cart waiting in the checkout area of the retail environment.

In some implementations, correlating the remaining identified objects in the translated image data with the other received data can include identifying a path or trip of activity of each of the identified objects throughout the retail environment. The computer system 102 may associate an identified guest with a cart in the image data and location data from the checkout area. The location data can provide an asset identifier associated with the cart. The computer system 102 can then identify location data received from other location signal devices throughout the retail environment that include the asset identifier associated with the cart. Piecing together, or otherwise correlating, this other location data can result in generation of a trip associated with the cart throughout the retail environment. The computer system 102 may further associate this trip with the particular guest that was identified in the image data with the cart. This trip can be used as insight by the computer system 102 determine, for example, what areas of the retail environment the guest frequents, what items the guest prefers, looks at, and/or chooses for purchase, and, more generally, overall activity and/or busyness throughout the retail environment.

Optionally, the computer system 102 may remove one or more of the objects that are not correlated with other data from the received data (block F, 212). Sometimes, block F (212) can be the same as or similar to block D (208). Block F (212) can be performed by applying the AI model(s) to the correlated data and/or the other received data. The computer system 102 may remove objects that represent team members and thus are not correlated to the other data indicative of guests waiting in line in the checkout area and/or performing a checkout process at a checkout lane. As another example, the computer system 102 may remove objects that appear in one FOV but do not appear in other, proximate FOVs. In some implementations, only one camera field of view may be used to generate computer vision insights described herein. Optionally, team member data (e.g., data representing team members in the checkout area) can be removed from raw image data received from the one camera field of view in order to clean the image data. In some implementations, re-identification computing techniques can also be performed between multiple camera FOVs. Although such re-identification techniques can be used to remove detected objects (such as a team member in the checkout area), these techniques can also be used to stitch together holistic visibility into guests and/or objects' journeys throughout the store. As yet another example, and as described above, the computer system 102 may remove objects that appear to be part of a unit of guests rather than individual guests (such as children shopping with a parent). As a result, the unit of guests can count as 1 spot in a wait line in the checkout area (or another area represented by the bounding box of block C, 206) rather than inaccurately representing a longer wait line.

The computer system 102 can generate a count of remaining objects in the bounding box, such as the bounding box associated with the checkout area where a wait line forms (block G, 214). The count can indicate how many guests are currently waiting in the line to perform checkout processes at checkout lanes/POS terminals. As described with regard to block F (212), the count can more accurately indicate groups or units of guests in the line, rather than counting each guest in a group or unit as an individual waiting in the line.

In block H (216), the computer system 102 can also generate wait time information based on the count of remaining objects and by applying the AI model(s) described herein. The information can indicate the current count of waiting guests in the line. The information can indicate a projected or estimated count of waiting guests in the line for one or more future periods of time. The information can indicate a current wait time in the line. The information can indicate a projected or estimated wait time in the line. The information can include a metric for busyness in the retail environment and/or near/in the bounding box (such as the checkout area).

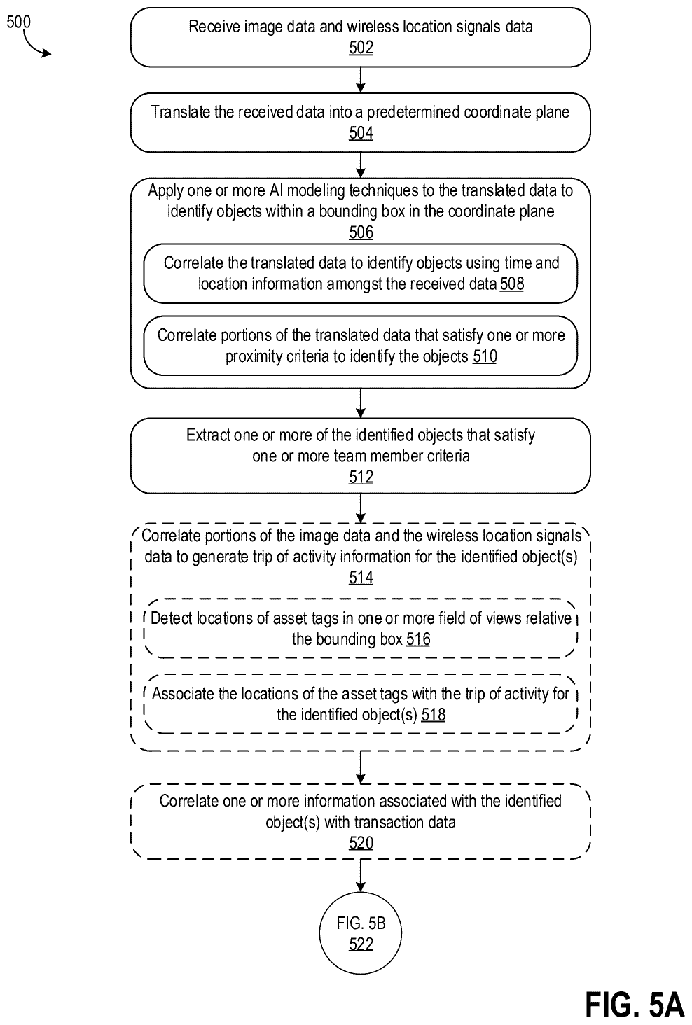

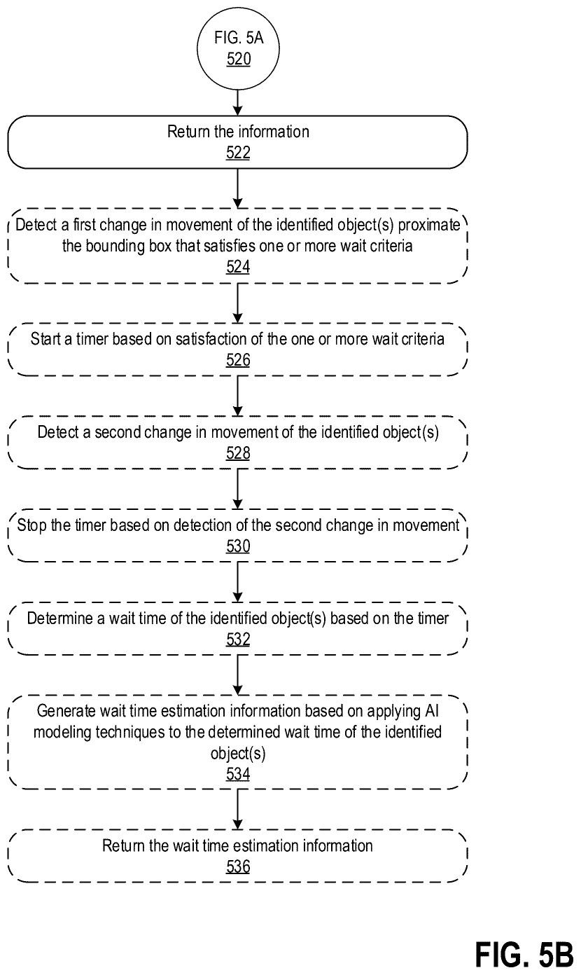

The AI model(s) can be trained using historical data for the retail environment and/or a network of retail environments to generate the wait time information. Seasonality information can also be used to train the AI model(s) to accurately determine current and/or projected/estimated wait time information in the particular retail environment. The AI model(s) can be trained, with the historical data and/or the seasonality information, to accurately determine/estimate peaks in wait time and/or busyness in the particular retail environment during holidays, annual sales, weekends, and/or in the evenings after working hours. Various other information can be used to train the AI model(s) to generate the wait time information. Moreover, as described in reference to FIGS. 5A and 5B, the AI model(s) can be iteratively trained to improve its generation of wait time information. For example, the generated wait time information can be fed back to the AI model(s) as training inputs. As another example, any of the translated image data, the identified objects in the translated image data, the correlated data, and/or the generated count of remaining objects can be provided as training inputs to improve.

In block I (218), the computer system 102 can return the information and/or the count of remaining objects. Returning such information can include storing the information in a data store, such as the data store 104 of FIG. 1A. Returning such information can include providing the information to computing devices of relevant users for internal use in association with the retail environment or a network of retail environments. The returned information can then be used to gain insights about activities and/or busyness in the retail environment. The returned information can be used to generate strategies for improving guest experiences in the retail environment, such as by adjusting a layout of the retail environment (in an effort to reduce congestion, lines, waits, and/or busyness) and/or adjusting operations in the retail environment during busy times (such as by opening more checkout lanes and/or having more team members working in the checkout area). In some implementations, the computer system 102 can automatically generate recommendations for improving the guest experiences in the retail environment. For example, the computer system 102 may automatically compare the generated wait time information to historic wait time information to determine whether the current wait time is higher than normal. If such a determination is made, the computer system 102 can determine that action should be taken to relieve congestion around checkout, such as sending additional team members to assist the guests in completing their respective checkout processes. The generated recommendations can be transmitted to the computing devices of the relevant users for review, implementation, and/or modification. Refer to at least FIG. 1A for further discussion about returning the information.

FIG. 2B is a conceptual diagram of a system 220 for determining guest information in a designated zone of an environment based on validating wireless location data with image data. Any operations described with regard to the system 220 can be performed using one or more AI models and/or machine learning techniques. The system 220 is similar to the system 200 of FIG. 2A. Whereas the system 200 validates the image data with the wireless location data, the system 220 can validate the wireless location data with the image data. Similar or same techniques can be performed by both systems 200 and 220.

In some implementations, image data can provide precise location data, and location data may be used simply to validate the image data. Sometimes, the image data can be susceptible to scenarios in which a computer system may mix up two different objects, such as when those objects pass over each other. In such examples, the location data (such as BLUETOOTH light energy asset tag data) can be used to differentiate the two objects that have been mixed up by the computer system. Different scenarios may also dictate whether and when to use which source (image data, location data) as base data and then augment with the other source. Both sources, image and location data, can have high accuracy, high fidelity over time (e.g., more frames per second), finer detail regarding additional context within coordinate planes (e.g., pose, interaction, orientation, sentiment), etc. While BLE or other wireless location detection can offer a wider field of view (such as of an entire store), it can serve as a foundational framework upon which to apply additional rich context. As an illustrative example, to identify rich context of a given path, the wireless location data can be used as the base data, and the image data can be used for augmentation. This use of the data can help visualize and determine whether, for example, a guest is oriented towards a product or signs and whether that orientation and interaction with the product/signs influenced the guest's path through the store when compared to other guest paths. As another illustrative example, the image data can be used as the base data and the wireless location data can be used for augmentation in order to identify behavior that occurred in a specific location of the store, such as interaction with high theft items. This usage of the data can be used to correlate back to a guest path in order to identify other areas in the store that a particular guest has been and/or is going.

In the system 220 of FIG. 2B, the computer system 102 can receive data from image and location signal devices in a retail environment in block A (222). Refer to block A (202) in FIG. 2A for further discussion.

The computer system 102 can translate location data of the received data into a predetermined coordinate plane in block B (224). The predetermined coordinate plane can correspond to an XY coordinate plane of the camera 108A. The predetermined coordinate plane can correspond to any other global coordinate plane/system. In some implementations, the location data may already be in the desired, predetermined coordinate plane. Therefore, the computer system 102 may not perform block B (224). Sometimes, the computer system 102 can perform block B (224) to translate image data of the received data into the predetermined coordinate plane.

The computer system 102 can identify objects in the translated data based on applying one or more AI models, where the objects are identified based on satisfying one or more object criteria (block C, 226). For example, the computer system 102 can identify only objects in the location data that have coordinates/locations corresponding to a particular area of interest (e.g., bounding box) in the retail environment, such as a checkout area where a guest wait line may form. Identifying those objects can include selecting identifiers and their coordinates/locations in the location data that correspond to the objects.

In block D (228), the computer system 102 can remove one or more of the objects from that data that satisfy one or more behavior and/or characteristics criteria. The computer system 102 may remove objects that, according to the location data, do not have a change in coordinates/locations for at least some predetermined period of time. Such objects may include team members and/or fixtures, such as checkout lanes and/or POS terminals in the checkout area. The computer system 102 may also perform object detection techniques on the image data of the received data to detect objects within a bounding box indicative of the particular area of interest (e.g., the checkout area). The computer system 102 can then determine whether each of the detected objects satisfy the one or more criteria. The one or more criteria, as described in reference to FIG. 2A, can be used by the computer system 102 to determine whether an object represents a guest or a team member. Any objects representing team members can be removed from the data.

The computer system 102 can then correlate remaining identified objects in the translated data with the image data and/or transaction data in the received data (block E, 230). The correlation(s) can be made based on one or more proximity criteria. As described in reference to FIG. 2A, the computer system 102 can identify, in the image data, objects, such as guests and assets, in the bounding box representing the checkout area. Identifying the objects in the image data can include identifying or extracting coordinates of the identified objects from the image data as well as time data associated with each of the coordinates. The computer system 102 can compare the extracted coordinates and the time data for the identified objects in the image data to the identified objects' coordinates and time data in the location data. If the coordinates of the image data and the location data are within a predetermined threshold distance of each other, and the time data is within some predetermined threshold time, then the computer system 102 can determine that those coordinates correspond to the same object, such as a guest waiting in line in the checkout area.

As another example, the computer system 102 can correlate the remaining identified objects with the transaction data based on (i) comparing the time data of the location data and/or the image data with time data of the transaction data and/or (ii) comparing object identifiers in the location data and/or the image data with object identifiers in the transaction data. The computer system 102 can correlate the objects with the transaction data in order to generate a holistic view into a trip of activity associated with each of the objects. The computer system 102 can also correlate the objects with the transaction data to determine and/or estimate how long guests may be waiting in a line in the checkout area before performing a checkout process (which generates the transaction data).

Optionally, the computer system 102 may remove one or more of the objects that are not correlated with other data from the received data (block F, 232). Refer to block F (212) in FIG. 2A for further discussion.

The computer system 102 can generate a count of remaining objects in the data in block G (234). For example, the computer system 102 can count a number of object identifiers remaining in the location data that has been correlated with the image data and/or the transaction data. The computer system 102 can validate the number of object identifiers remaining in the location data with a count of objects identified in the image data. Refer to block G (214) in FIG. 2A for further discussion about generating the count.

In block H, the computer system 102 can generate wait time information based on the count of remaining objects and by applying the AI model(s) (236). Refer to block H (216) in FIG. 2A for further discussion.

The computer system 102 can then return the information and/or the count of remaining objects in block I (238). Refer to block I (218) in FIG. 2A for further discussion.

FIG. 2C is a conceptual diagram of a system 240 for processing image data and wireless location data separately, then combining the data to determine guest information. The system 240 of FIG. 2C can provide additive techniques for accurate identification of objects in an environment, such as guests waiting in line in a checkout area of a retail environment. The additive techniques can include separately processing the image data and the wireless location data, then combining the processed data to generate a superset. The additive techniques can be beneficial where an object, such as a guest, may appear in the image data but may be ‘invisible’ to location signal devices because the object does not have any devices, assets, or tags that can be identified/tracked by the location signal devices. One or more blocks performed by the system 240 in FIG. 2C are similar or the same as the blocks performed by the systems 200 and 220 in FIGS. 2A and 2B, respectively.

In the system 240 of FIG. 2C, the computer system 102 can receive data from image and location signal devices in a retail environment (block A, 242). Refer to block A (202) in FIG. 2A for further discussion.

The computer system 102 can translate image data of the received data into a predetermined coordinate plane in block B (244). Refer to block B (204) in FIG. 2A for further discussion.

The computer system 102 can translate location data of the received data into the coordinate plane in block C (246). Refer to block B (224) in FIG. 2B for further discussion.

Blocks B and C (244 and 246, respectively) can be performed in parallel, in series, simultaneously, and/or at different times. Sometimes, only one of the blocks B and C (244 and 246, respectively) may be performed. Refer to block B (224) in FIG. 2B for further discussion.

The computer system 102 can combine the translated image data and location data into a superset in block D (248). The data combined into the superset can all have the same predetermined coordinate plane, which allows for accurate object location identification and correlation across the superset.

In block E (250), the computer system 102 can identify objects in a bounding box in the superset based on applying one or more AI models, where the objects are identified based on satisfying one or more object criteria. The bounding box can be predetermined by the computer system 102 and can correspond to a checkout area in the retail environment. The bounding box can be designated by coordinates in the predetermined coordinate plane. Identifying the objects in the bounding box can include identifying objects/identifiers in the superset having coordinates that are within bounds of the coordinates designated for the bounding box. Refer to block C, 226, in FIG. 2A and block C, 246, in FIG. 2B for further discussion about ways to identify the object that satisfy the one or more object criteria.

Optionally, the computer system 102 may remove one or more of the objects from the superset that satisfy one or more behavior and/or characteristics criteria (block F, 252). Refer to at least blocks D (208) and F (212) in FIG. 2A and blocks D (228) and F (232) in FIG. 2B for further discussion.

The computer system 102 can generate a count of the remaining objects in the superset in block G (254). Refer to at least block G (234) in FIG. 2B for further discussion.

The computer system 102 can also generate wait time information based on the count and by applying the AI model(s) in block H (256). Refer to at least block H (236) in FIG. 2B for further discussion.

In block I (258), the computer system 102 can return the information and/or the count. Refer to at least block I (238) in FIG. 2B for further discussion.

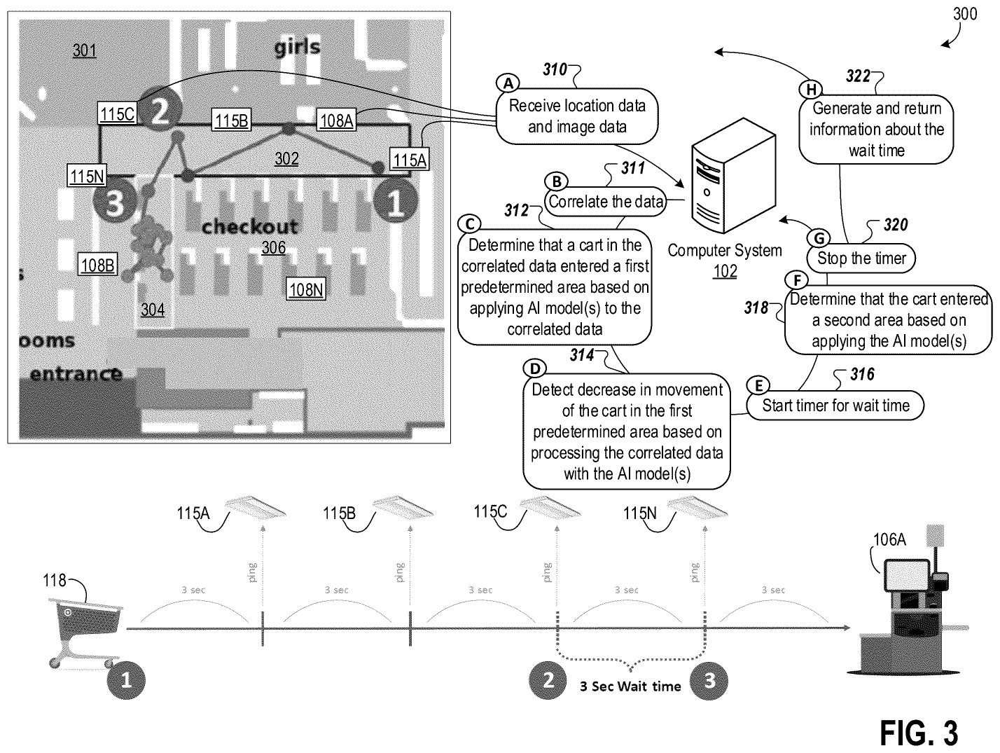

FIG. 3 is a conceptual diagram of a system 300 for determining guest wait time near a checkout area 306 of a retail environment or store 301. The checkout area 306 can include a self-checkout area 304. The retail environment 301 can also include a wait area 302, which may lead to the checkout area 306 and/or the self-checkout area 304. In some implementations, lines of guests can form in the wait area 302 for either the checkout area 306 or the self-checkout area 304. In the example of FIG. 3, the system 300 is described from the perspective of determining guest wait information for the self-checkout area 304. The system 300 can also be used to determine guest wait information for the checkout area 306 and/or a combination of the checkout area 306 and the self-checkout area 304.

As shown in FIG. 3, the store 301 also includes the cameras 108A-N and the overhead sensor 115A-N(e.g., overhead lights). One or more other location signal devices can also be positioned throughout the store 301, as described herein. Here, the camera 108A and the overhead sensors 115A, 115B, and 115C are positioned proximate or relative the wait area 302. The overhead sensor 115N is positioned proximate the wait area 302 and the self-checkout area 304. The camera 108B is positioned proximate the self-checkout area 304. The camera 108N is positioned proximate the checkout area 306. One or more other, additional, or fewer cameras and/or overhead lights can be positioned throughout the store 101 and the designated areas described herein. Each of the cameras 108A-N can have a fixed, predetermined vantage point, or FOV. As described herein, regardless of the camera FOV, image data from the cameras 108A-N can be translated to a predetermined XY coordinate plane, such as a global coordinate plane of location data received from the overhead sensors 115A-N.

In the system 300, the computer system 102 can receive location data and image data from the overhead sensors 115A-N and the cameras 108A-N in the store 301 (block A, 310). As described herein, the data can include computer vision and wireless location signals. The data can be received continuously. In some implementations, the computer system 102 can ping the overhead sensors 115A-N and/or the cameras 108A-N for the respective data at predetermined time intervals. As an illustrative example, the computer system 102 can ping the overhead sensors 115A-N at 3 second intervals. Sometimes, the computer system 102 can ping less than all the overhead sensors 115A-N. The computer system 102 can, for example, ping each successive overhead sensor in 3 second intervals (115A, then 115B, then 115C . . . etc.). The data can be transmitted according to various other timing intervals.

The computer system 102 can correlate (e.g., combine) the received data in block B (311). Refer to at least FIGS. 1A, 1B, 1C, 2A, 2B, and 2C for further discussion about correlating the received data. In brief, correlating the received data can include translating the image data to a coordinate plane that is also used by the location data. Correlating the received data can also include identifying objects in the data that satisfy one or more object criteria, such as objects that represent guests and/or assets. Correlating the received data can further include identifying objects that appear in both the location data and the translated image data that satisfy one or more coordinates, timing, or other location criteria and correlating such data.

In block C (312), the computer system 102 can determine that a cart 118 (or other asset or guest) in the correlated data entered a first predetermined area based on applying one or more AI model(s) to the correlated data. The first predetermined area can include the wait area 302. The AI model(s) can be trained to detect presence of the cart 118 in the wait area 302 and movement of the cart 118 within that area 302. The wait area 302 can be defined by a bounding box. If the cart 118 is detected as entering the wait area 302 and then leaving the wait area 302 (based on analysis of movement information associated with the cart 118), such as by going into another area of the store 301 that does not include the self-checkout area 304 or the checkout area 306, the model(s) can generate information indicating that the cart 118 is not in fact an object that may be associated with a guest wait line. Instead, the cart 118 may be associated with a guest that is still shopping in the store 101. In block C (312), computer vision techniques may also be applied to the image data to identify geometry and movement patterns indicative of guests, assets (e.g., the cart 118), and/or team members in the store 301.

The computer system 102 can detect a decrease in movement of the cart 118 in the first predetermined area based on processing the correlated data with the AI model(s) (block D, 314). For example, the computer system 102 can compare an amount of time between detection of the cart 118 in location data from the overhead sensor 115A, 115B, and then 115C. If the amount of time between each detection equals some predetermined time value and/or exceeds some predetermined time threshold, then the computer system 102 can determine that the cart 118 is slowing down in speed within the wait area 302. If the cart 118 is slowing down in speed within the wait area 302, then the cart 118 is likely associated with a guest waiting to perform a checkout process in the self-checkout area 304 (or the checkout area 306) rather than a guest continuing to shop in the store 301. In the example of FIG. 3, the computer system 102 can detect that the cart 118 is decreasing in speed/movement as location data is received from the overhead sensors 115A, 115B, and 115C as the cart 118 passes under those or within FOVs/ranges of those lights.

As another example, the computer system 102 can determine whether the cart 118 decreases in movement within the wait area 302 based on processing the image data captured by the cameras 108A, 108B, and/or 108N. Using the disclosed techniques, the computer system 102 can identify the cart 118 in the image data and generate a bounding box around the identified cart 118 in the image data. Using computer vision techniques, the computer system 102 may track movement of the bounding box for the identified cart 118 across the image data and determine whether, over time (such as a predetermined time threshold), the bounding box for the identified cart 118 is slowing down in movement. Sometimes, the computer system 102 can validate the determination that the cart 118 is slowing down in movement in the image data by using the location data described above. As another example, the computer system 102 can validate the determination that the cart 118 is slowing down in movement in the location data by using the image data.

Once the computer system 102 detects the decrease in movement of the cart 118, the computer system 102 can start a timer for wait time (block E, 316). In other words, using computer vision techniques and/or the AI model(s), the computer system 102 can detect a change in speed of the geometry of the cart 118 (or the guest associated with the cart 118) as it moves across the image data and/or the location data. The computer system 102 can detect a decrease in speed. Sometimes, the computer system 102 can detect an increase in speed followed by a decrease or a stop in speed (e.g., the guest has moved to a back of a wait line and therefore is no longer moving while in line). The AI model(s) can, for example, be trained to detect movement indicative of the cart 118 and/or the associated guest slowing down in the wait area 302, which triggers a starting point for determining how long that guest waits before proceeding to checkout.

The timer can be started for example, once the cart 118 is detected as reaching a start of a line in the wait area 302 (such as when no line has formed yet in the wait area 302). The timer can be started once the cart 118 is detected as reaching a back of the line in the wait area 302 (such as when a line has already formed in the wait area 302). The timer can be started once the cart 118 is detected as reaching a predetermined speed or movement in the wait area 302 (such as when the cart 118 is approaching a line). The timer can be started once the cart 118 is detected as reaching an edge of the wait area 302, just before the self-checkout area 304 and/or the checkout area 306. In the example of FIG. 3, the computer system 102 can start the timer once the cart 118 is detected in location data that is generated by the overhead sensor 115C.

The computer system 102 can determine that the cart 118 entered a second area in the store 301 based on applying the AI model(s) (block F, 318). The second area can include the self-checkout area 304. Sometimes, the second area can also include the checkout area 306 or a portion thereof. Similar to block C (312), the model can be trained to detect movement of an object as it is seen moving from the bounding box representing the first area to a bounding box representing the second area. In the example of block F (318), once the model identifies that the cart 118 has entered the bounding box representing the second area (e.g., the self-checkout area 304), the model can output a notification indicating that the cart 118 is no longer in the wait area 302 and therefore a guest associated with the cart 118 is likely no longer waiting to proceed to checkout.

Accordingly, in block G (320), the computer system 102 can stop the timer. As described in reference to block E (316), the computer system 102 may determine when to stop the timer using computer vision techniques and/or the AI model(s). The computer system 102 can determine to stop the timer based on detecting that the geometry identifying the cart 118 (or the guest associated with the cart 118) has an increase in speed and/or is moving from one area to a next, as described in reference to block F (318) above. Stopping the timer can indicate that the guest associated with the cart 118 is likely no longer waiting to proceed to checkout and now has moved to a defined checkout lane zone in the self-checkout area 304 (or the checkout area 306 in some implementations).

In the illustrative example of FIG. 3, a 3-second wait time was identified between points 2 and 3, point 2 being in the wait area 302 and point 3 being in the self-checkout area 304.

Points 2 and 3 also indicate locations of overhead sensors 115C and 115N, respectively, which were pinged by the computer system 102 in block A (310) and provided location data representative of the cart 118 to the computer system 102. By correlating this location data with the image data from the cameras 108A-N, the computer system 102 verified and validated that the cart 118 entered the wait area 302 near the overhead sensor 115A, moved along the wait area 302 past the camera 108A, the overhead sensor 115B, and the overhead sensor 115C, before eventually moving into the self-checkout area 304. In the self-checkout area 304, location data from the overhead sensor 115N was used by the computer system 102 to verify that the guest associated with the cart 118 stopped at a designated POS terminal 106A to perform the checkout process. Image data from the camera 108B could be used by the computer system 102 to verify that the guest associated with the cart 118 completed the checkout process at the POS terminal 106A and left the self-checkout area 304.

The total time that the timer was activated can indicate a total time that the particular guest waited before the checkout process could begin. The total time that the timer was activated can indicate a total time from which the guest began slowing down in the wait area 302 to when the guest entered the self-checkout area 304 (or the checkout area 306). The total time that the timer was activated can also be stored in a data store in association with a transaction that subsequently occurs for the particular guest. The total time that the timer was activated can also be stored in association with an identifier of the cart 118. The total time that the timer was activated can be stored in association with the particular guest. In some implementations, the total time that the timer was activated may not be stored in association with any guest or asset in the store 301. Rather, the total time can be stored as one of many data points indicating wait times in the particular store 301.

Sometimes, guests and/or their associated assets may not pass through the wait area 302 or may only partially pass through the wait area 302 before going to the self-checkout area 304 or the checkout area 306. Sometimes, a wait line may form outside of the wait area 302. Regardless of whether the guests and their associated assets pass through the wait area 302, detection and calculation of their speed of acceleration or deceleration near the self-checkout area 304 and the checkout area 306 can be used, by the computer system 102, to determine when to trigger the timer for wait time. Whether the guest and their associated assets actually pass through the wait area 302 can then be used to verify and validate the computer system 102's determination to trigger the timer.

In yet some implementations, the guest and/or their associated assets can be detected by the computer system 102 as having relatively consistent speed passing through the wait area 302. The consistent speed can indicate that there is no current wait line and the guest is moving towards a first available POS terminal. The consistent speed can also indicate that the guest is in line but the line is moving (rather than stop and go). Where the guest has consistent speed in the wait area 302, the computer system 102 can ping one or more of the overhead sensors 115A-N and/or the cameras 108A-N near the self-checkout area 304 or the checkout area 306 for data indicating movement of the guest and their associated asset(s) (e.g., the cart 118). As an illustrative example, the computer system 102 can detect from the received data that the cart 118 is moving at a relatively consistent speed through the wait area 302. The computer system 102 can then ping the overhead sensors 115C and 115N requesting location data. The computer system 102 can compare that requested location data to the received data for the cart 118 to determine whether the cart 118 is in fact moving through the wait area 302 to go to a POS terminal in the self-checkout area 302 (or the checkout area 304). Therefore, the computer system 102 can confirm the cart 118 is in fact approaching the self-checkout area 302 and use all the received data for the cart 118 to start and stop the timer while the cart 118 is in the wait area 302.

In some implementations, even if the cart 118 begins slowing down in speed as it enters the wait area 302, the computer system 102 can ping one or more of the cameras 108A-N and/or the overhead sensors 115A-N for data. The computer system 102 can process the data and correlate it to confirm that the cart 118 is in fact slowing down to go to checkout (and not simply slowing down because the guest associated with the cart 118 is still shopping, or it's very busy around the wait area 302 causing traffic, or other reasons). Once the computer system 102 confirms that the cart 118 is in fact slowing down for checkout purposes, the computer system 102 can use the received data to determine when to start and stop the timer to measure the wait time of the cart 118 in the wait area 302.

The computer system 102 can then generate and return information about wait time (block H, 322). This information can be transmitted to computing devices of relevant users, such as team members in the store 301. The information can indicate the actual wait times of guests over one or more periods of time at the store 301 (e.g., times recorded using the timer as described above). Sometimes, the information can indicate projected or expected wait times of guests in the store 301 over one or more future periods of time (which can be based on the determinations made by the computer system 102 in tracking the wait times of guests in the store 301 using the disclosed techniques). For example, the computer system 102 can apply one or more AI models to the returned information (actual wait times of guests in the store 301) to output estimated guest wait times in the store 301 during one or more future periods of time.

In some implementations, the computer system 102 may associate the correlated data from block B (311) with transaction data from a POS terminal in the self-checkout area 304. As a result, the computer system 102 can verify the data that was correlated in block B (311) and the determination that the guest associated with the cart 118 had been waiting in the wait area 302 for the amount of time that the timer was activated. An association with the transaction data can also provide for generating a mapping or trip history for the particular guest. This information can be used to glean insights into the guest's preferences, shopping history, and overall shopping experience at the store 301.

FIG. 4A illustrates the example cart 118 that can communicate wirelessly with an indoor wireless location signaling system 400 to transmit and/or receive wireless location signals. More specifically, the cart 118 can include an asset signaling device 401. The asset signaling device 401 can communicate with the indoor wireless location signaling system 400 via the network(s) 124. Wireless location signals that are transmitted and received between the asset signaling device 401 and the indoor wireless location signaling system 400 can be used (such as by the computer system 102 described herein) to identify a location of the cart 118 as it moves through a physical space, such as a retail environment or store.

The asset signaling device 401 can include a tag 116, a transmitter 408, and a receiver 410. The tag 116 can be configured to uniquely identify the particular asset (e.g., the cart 118). The tag 116 can be an RFID tag or any other tag described herein. The transmitter 408 can be configured to transmit wireless signals, such as WIFI signals, over the network(s) 124, to the indoor wireless location signaling system 400. The receiver 410 can be configured to receive wireless signals over the network(s) 124 from the system 400.

Sometimes, the device 401 may include the tag 116 and the transmitter 408 but not the receiver 410. Sometimes, the device 401 may include the tag 116 and the receiver 410 but not the transmitter 408. Various other configurations are also possible. In yet some implementations, the tag 116 may not be part of the asset signaling device 401, and can instead be a standalone component that is attached/affixed to or embedded in the cart 118. Any of the tag 116, the transmitter 408, and the receiver 410 can be part of the cart 118, affixed to the cart 118, and/or embedded within the cart 118.

The indoor wireless location signaling system 400 can include the overhead sensors 115A-N, the wireless signaling devices 110A-N, beacons 402A-N, or any combination thereof. Any of the components 115A-N, 110A-N, and 402A-N can be positioned throughout the retail environment (e.g., store), as described herein. The retail environment may also include multiple indoor location signaling systems, in some implementations. The overhead sensors 115A-N(e.g., overhead lights), as described herein, can transmit and/or receive low energy signals, such as a pulse rate of the lights. In some implementations, signals from sensors or other devices (e.g., the cameras 108A-N) can also be collected and processed with machine learning models and techniques (e.g., by the computer system 102) to determine angle and intensity of the light pulses, which further can be used to pinpoint a location of the sensors 115A-N(or the cart 118). The wireless signaling devices 110A-N can be configured to receive and/or transmit WIFI signals, BLUETOOTH signals, BLUETOOTH LTE signals, or any other type of wireless signals. The beacons 402A-N can include WIFI or other wireless communication devices that can provide for active and/or passive communication with components of the asset signaling device 401. The beacons 402A-N can, for example, broadcast WIFI or other wireless signals to nearby devices, such as the asset signaling device 401.

The asset signaling device 401 and the indoor wireless location signaling system 400 can provide for passive and/or active signaling techniques. For example, in a passive implementation, the indoor wireless location signaling system 400 can transmit/send signals (block A, 412) to the asset signaling device 401 and can receive a response (e.g., return signals) from the asset signaling device 401 (block B, 414). In an active implementation, the indoor wireless location signaling system 400 can poll devices, such as the asset signaling device 401, for active signals and may receive those active signals available for transmission back to the system 400. In the active implementation, the system 400 and/or the device 401 may transmit signal location information as well as the signals back and forth, between each other.

In an illustrative example of the cart 118, the cart 118 can include the transmitter 408. The transmitter 408 can transmit beacon signals (e.g., continuously, at predetermined time intervals, periodically). Sometimes the signals can be pulsing signals. The beacon signals can be received by one or more of the wireless signaling devices 110A-N that are within some threshold distance/range from the cart 118 as the cart 118 moves through the retail environment. When the wireless signaling devices 110A-N receive the signals, the devices 110A-N can transmit the signals to the computer system 102 described herein for further processing. The further processing can be performed to determine a location of the cart 118 as it moves throughout the retail environment. In some implementations, the indoor wireless location signaling system 400 may include a processor (not depicted), which can be configured to process the received signals and identify the location of the cart 118. The processor can then transmit such location information to the computer system 102 for additional processing in relation to the techniques described herein.

FIG. 4B illustrates an example basket 420 that can communicate wirelessly with the indoor wireless location signaling system 400 to transmit and/or receive wireless location signals. The basket 420 can be used by guests in a retail environment, such as a store, to collect and carry items for purchase around the retail environment. Like the cart 118, the basket 420 can include the asset signaling device 401 with one or more of a respective tag 116, the transmitter 408, and the receiver 410. Any components of the device 401 can communicate over the network(s) 124 with the indoor wireless location signaling system 400. The system 400 can include the overhead sensors 115A-N, the wireless signaling devices 110A-N, and/or the beacons 402A-N. Refer to FIG. 4A for further discussion about the asset signaling device 401 and the indoor wireless location signaling system 400.

The asset signaling device 401 and the indoor wireless location signaling system 400 can send and receive wireless signals amongst each other and via the network(s) 124 (blocks A and B, 422 and 424 respectively). Refer to FIG. 4A for further discussion about such signal communications.

The system 400 can then transmit or send signal information to the computer system 102 via the network(s) 124 (block C, 426). Sometimes, the asset signaling device 401 can transmit the signal information to the computer system 102 via the network(s) 124. The signal information can include location data indicating where a location signal between the asset signaling device 401 and the system 400 was identified, an identifier associated with the asset signaling device 401 that was identified, timestamp or other timing information of the identified location signal, signal strength/pulse information, and other related information.

Based on processing the received signal information, the computer system 102 can determine angle and/or intensity of location signal pulses (block D, 427). Sometimes, processing the signal information can include applying a machine learning model that was trained, using historic signal information associated with the retail environment or other retail environments/physical spaces, to determine angle and/or pulse intensity for different wireless signals. The angle and/or pulse intensity determinations can be used by the computer system 102 to accurately and efficiently detect/identify an object associated with the particular wireless signals in a particular location of the retail environment.

The computer system 102 can also receive information about a physical space having the indoor wireless location signaling system 400 (block E, 428). The physical space can be the retail environment described above. It can be appreciated that the disclosed techniques can also apply to other physical spaces, including but not limited to warehouses, facilities, factories, residential buildings/homes, office buildings, outdoor spaces, commercial buildings, etc. sometimes, the information in block E (428) can be received before, during, or after any of the blocks A (422), B (424), C (426), and/or D (427). The information can be received from a data store. The information can be received from another computing system, such as a computing system associated with the physical space.

The information can include a map or other layout of the entire physical space. The information can include location data indicating locations of various signaling devices in the physical space (e.g., locations of the sensors 115A-N, the wireless signaling devices 110A-N, and/or the beacons 402A-N, other sensors). For example, the information can include a listing of the signaling deices of the physical space, where the signaling devices are associated with respective IDs and location coordinates. The information can sometimes include last-known/available location information associated with the asset signaling device 401 of the basket 420. As another illustrative example, a map of the entire physical space can be established/determined. Then a location system can be set to a standard coordinate system that is used for the map. The location system, which may include any of the wireless signaling devices described herein, can output information such as a device ID, timestamp, X/Y coordinates, source information, and/or an indication of how a particular location was determined/identified. Such output information can then be combined with the map and associated map information to gain store context (e.g., to determine where the X/Y coordinates are within the store). Moreover, homography techniques, as described herein, can be used to layer additional inputs, such as image data, to gather further context and insight into activity, movement, and/or objects in the entire physical space. Accordingly, the coordinate system can be used as a unifier to overlay and/or join information together, as described herein.

In block F (429), the computer system 102 can detect an object (e.g., the basket 420) and/or location of the object in the physical space using machine learning and based on the determined angle/intensity of the signals and the information about the physical space. For example, the computer system 102 can determine location coordinates (XYZ coordinates) associated with a location where the asset tag 116 (or the device 401) pinged the system 400. The basket 420 may be identified by a device ID associated with the device 401 or the asset tag 116, and the location coordinates may be based on location coordinates of the system 400 (or a particular sensor or device of the system 400) that received a beacon signal or other wireless signal from the device 401. Sometimes, the location coordinates can be based on signal strength data corresponding to one or more components/devices/sensors of the system 400. In yet some implementations, the computer system 102 can determine in block F (429) a type of device that transmitted or relayed a wireless location signal, such as the asset tag 116 or any other components described herein. As another example, the computer system 102 can determine the location of the object in the physical space and compare the coordinates of that location to coordinates for designated zones of the physical space. The computer system 102 can generate a notification if the location of the object is identified as being within the coordinates of a wait area in the physical space. This identification of location can further be used by the computer system 102 to determine whether the object is waiting in a line at checkout and how long the object is waiting in the line, as described herein.

As another illustrative example, the computer system 102 can receive, as inputs, a map of the physical space with context normalized to a coordinate plane, locations of devices and/or asset tags in a time series on the same coordinate plane, and image data (e.g., pixel-based) that may require additional processing to align to the same coordinate plane. The computer system 102 can then process and overlay/join/combine these inputs in order to generate output. The output can include a detected object and/or location information associated with the object.

The computer system 102 can return object information in block G (430). The object information can include a location of the object or locations of the object as it is moved throughout the retail environment (e.g., the physical space). The information can include designation of zones in a map of the retail environment where the object was identified and/or where the object was identified as idle/in the same place or location for more than a threshold period of time (which can indicate that the object was in a wait line for checkout). The information can also include an identifier for the particular object. In some implementations, the information can include an association between the particular object and a guest in the retail environment.

The object information can be returned to a data store for storage and later retrieval/use. The object information can be transmitted to computing devices of one or more relevant users in the retail environment. As described herein, the object information can be used to track movement of the object throughout the retail environment and in a wait area before checkout. The object information can further be used to determine how long the object is located within the wait area before the object moves to a self-checkout lane or a manual checkout lane.

FIG. 4C illustrates an example mobile device 112 that can communicate wirelessly with an indoor wireless location signaling system to transmit and/or receive wireless location signals. The mobile device 112 can be any type of personal computing device, including a cellphone, smartphone, tablet, and/or laptop. The mobile device 112 can be carried and/or used by a guest in a retail environment, such as the store 101. The mobile device 112 can connect to a wireless internet connection (WIFI) offered and available at the store 101. Once connected to a local network, such as the network(s) 124, in the store 101, the guest can use the mobile device 112 to enhance their shopping experience. For example, the guest can access a mobile application 446 presented in a graphical user interface (GUI) display at the device 112. Using the application 446, the guest can search for items to purchase in the store 101, search for items to add to their virtual shopping cart to purchase separately or with items that the guest physically selects in the store 101, see whether items in the store 101 are in stock or out of stock, pick up an order that has been fulfilled in the store 101, etc.

The mobile device 112 can passively communicate with other devices and sensors in the store 101, including but not limited to sensors 115A-N, wireless signaling devices 110A-N, and/or beacon(s) 402. Similar to the asset signaling device 401 described in both FIGS. 4A and 4B, the mobile device 112 can listen for wireless signals (block A, 440) and/or send and receive wireless signals (block B, 442) from any of the abovementioned devices and sensors as the mobile device 112 is moved throughout the store 101. Any of the sensors 115A-N, the wireless signaling devices 110A-N, and/or the beacon(s) 402 can also transmit signal information to the computer system 102 for further processing (e.g., identifying a location of the mobile device 112), as described further in reference to FIG. 4B.

As an illustrative example, the mobile device 112 can emit wireless or cellular signals as the mobile device 112 is moved throughout the store 101. Such signals can be emitted whenever the application 446 is open on the device 112 or accessed by the guest. Such signals can be periodically emitted by the mobile device 112 regardless of whether the application 446 is being used. Any of the sensors 115A-N, the wireless signaling devices 110A-N, and/or the beacon(s) 402 that are proximate the mobile device 112 can passively listen for those signals emitted by the device 112. These devices and/or sensors can also listen for other signal information that may be transmitted by the mobile device 112, such as mobile device identifiers, signal strength data, signal pulse data, timestamps, location data/coordinates, etc.

As another example, the mobile device 112 can passively listen for wireless or cellular signals from any of the sensors 115A-N, the wireless signaling devices 110A-N, and the beacon(s) 402 that may be proximate the mobile device 112 as it is moved throughout the store 101. The sensors 115A-N, the wireless signaling devices 110A-N, and/or the beacon(s) 402 can transmit the signals (e.g., periodically, at predetermined intervals, pulsating), which can be received by the mobile device 112. The mobile device 112 can transmit signal information back to any of the abovementioned sensors and/or devices in response to listening for and receiving the emitted signals. As another illustrative example, mobile devices of team members can be used as sensors to listen for and detect other beacons and/or asset tags.

FIGS. 5A and 5B is a flowchart of a process 500 for correlating different signals to determine guest wait time information in an environment, such as a retail environment, store, or other physical space described herein. The process 500 can be performed to identify objects, such as guests and assets, that appear within a designated wait zone in the store and how long such objects remain within the designated wait zone before moving to another zone (such as a zone for self-checkout or manual checkout). As a result, a determination can be made as to how long a identified object waited in the wait zone before being able to proceed to perform a checkout process.

The process 500 can be performed by the computer system 102. The process 500 can also be performed by one or more other computing systems, devices, computers, networks, cloud-based systems, and/or cloud-based services. For illustrative purposes, the process 500 is described from the perspective of a computer system.

Referring to both FIGS. 5A and 5B, the computer system can receive image data and wireless location signals data in block 502. The image data can include videos and/or images captured by one or more cameras or similar imaging devices positioned in the retail environment. The wireless location signals data can include location data that is generated/transmitted by overhead lights and/or wireless location signaling devices in the retail environment. Refer at least to FIGS. 1A and 1B for further discussion.

In block 504, the computer system can translate the received data into a predetermined coordinate plane. Sometimes, the computer system may only translate some of the data into the predetermined coordinate plane. For example, the image data can be captured from a field of view of the respective capturing camera. The field of view can employ a different coordinate system than the coordinate system employed by wireless location signaling devices. The image data can also be translated from the coordinate system of the capturing camera to the coordinate system of a mapping of the physical space/retail environment. This coordinate system can be a global coordinate system in X, Y, and Z dimensions. Sometimes, both the image data and the wireless location signals data can be translated to a same coordinate system, such as the global coordinate system. Refer to at least FIG. 1B for further discussion.

The computer system can apply one or more AI modeling techniques to the translated data to identify objects within a bounding box in the coordinate plane in block 506. For example, in block 508, the computer system can correlate the translated data to identify objects using time and location information amongst the received data. As another example, the computer system can correlate portions of the translated data that satisfy one or more proximity criteria to identify the objects (block 510). The computer system can correlate the received data in an additive approach, as shown and described in FIG. 2C. The computer system can correlate the received data in a subtractive approach, as shown and described in FIG. 2A. Sometimes, the image data can be used to confirm identification of objects in the wireless location signals data. Sometimes, the image data can be used to supplement or annotate the wireless location signals data, or vice versa. As an illustrative example, a guest may grab an item and wait in line at a self-checkout area without a phone or other asset that can be located using wireless location signaling devices. The computer system can analyze the image data of the self-checkout area to identify the guest and thus supplement the wireless location signals data, the wireless location signals data indicating other guests in the self-checkout area but not the guest with the item and no phone/asset. Both the image data and the wireless location signals data are reliable and can be used interchangeably. The image data can serve as a validation set for the wireless location signals data, in some implementations. The wireless location signals data can also offer a broad perspective beyond cameras' field of view, which can provide additional data points on guest behavior in the retail environment.

As an illustrative example of block 506, the computer system can obtain a plurality of image data captured at one or more different time periods from one or more different cameras/imaging devices. The computer system can select any of the image data of any same or different time period. The computer system can apply AI techniques, for example, to the selected image data to identify objects within that image data. The computer system can further draw annotations on top of the selected image data based on identifying the objects therein. The computer system can perform additional computer analysis techniques, including but not limited to generating a heatmap and/or a trail showing movement of each identified object across the selected image data. Sometimes, if the computer system determines that a particular identified object appears in some successive image data but not others (e.g., a guest is identified in a clip at time t=0, then do not appear in a successive clip at time t=1, but appears in a next clip at time t=2), the computer system can decide to remove such image data from its analysis in the subsequent blocks. In other words, the data where the guest is missing or appears in some but not all successive image data may be erroneous and may not be used for determining or estimating guest wait times in the retail environment. Sometimes, the computer system can generate an average of the image data to be used in the techniques described below for determining or estimating the guest wait time.

An AI model can be trained to identify the objects in the image data. The objects can include but are not limited to guests, assets (e.g., carts, baskets), items available for purchase in the retail environment, and/or team members (e.g., employees). The AI model can be a computer vision model. The model can be trained with computer vision techniques and historic data (e.g., images/videos) of objects in the retail environment or in other retail environments. For example, the model can be trained with historic data that has been annotated with people (e.g., guests, team members), assets (e.g., carts, baskets), and items to identify such objects in new/other image data. Over time, the model can learn (or otherwise be iteratively trained to learn) how to differentiate between the different types of objects. For example, the model can be trained to differentiate between a guest and a team member based on histogram colors indicative of their clothes and/or accessories (e.g., all team members may wear the same color and/or clothes, or wear badges or other designations on their bodies).

Once the model identifies the objects and annotates those objects in the image data (e.g., by generating a bounding box around the object), the model can generate output. The output can include, for each identified object or for a particular identified object (such as a guest), coordinates (e.g., X, Y, and/or Z coordinates) of the identified object, an identifier for the object, and/or an indication of whether the object is a guest, item, asset, and/or team member. The generated coordinates can be within the global coordinate system mentioned above. In some implementations, the generated coordinates may still be in the coordinate system of the cameras. As a result, the computer system may then translate the generated coordinates to the global coordinate system.

The computer system can extract one or more of the identified objects that satisfy one or more team member criteria in block 512. Sometimes, block 512 may optionally be performed. Block 512 can be performed to remove any team members from the data so that the team members do not count in determining the guest wait time at the retail environment. The one or more team member criteria can include characteristics and attributes that are indicative of team members and/or their behavior in the retail environment. For example, the characteristics and attributes can include color of clothing/accessories/badges/other visual indicators worn by people identified in the image data, a length of time that an identified person appears in one location in the image data (the longer the person remains in place, the more likely they are a team member surveying the checkout area), whether the identified person moves between checkout lanes (the more the person moves between the lanes, the more likely they are a team member assisting guests at the checkout lanes), etc. The model(s) described herein can be trained to determine whether each of the identified objects satisfies the one or more team member criteria.

Sometimes, extracting the objects that satisfy the one or more team member criteria can include marking bounding boxes for those objects as being associated with team members. Marking the bounding boxes as such can provide an indicator to the computer system that the respective objects are not to be tracked/considered for determining the guest wait time. In other implementations, the computer system can remove the bounding boxes around the respective objects so that those objects are no longer tracked/considered for determining the guest wait time.

Optionally the computer system can correlate portions of the image data and the wireless location signals data to generate trip of activity information for the identified object(s) (such as once both data are aligned to a common coordinate system) (block 514). The correlation can be performed similarly to techniques described herein to blend together various data inputs, those techniques including but not limited to correlation based on time and proximity and/or object classification. For example, the computer system can optionally detect locations of asset tags in one or more field of views relative the bounding box (block 516). As another example, the computer system can optionally associate the locations of the asset tags with the trip of activity for the identified object(s) (block 518). In some implementations, blocks 514, 516, and 518 can be similar to or otherwise performed as part of blocks 508 and 510.

Optionally, the computer system can correlate one or more information associated with the identified object(s) with transaction data in block 520. Refer to process 600 in FIG. 6 for further discussion. In brief, correlating the objects with the transaction data can allow for confirming wait times associated with each of those objects. Sometimes, as described further below, the wireless location signals data can be correlated with the transaction data to determine wait time of guests in the retail environment, especially in implementations where the retail environment does not include cameras or similar imaging devices. Likewise, the transaction data can be correlated with image data where the retail environment does not have wireless location signaling devices in order to determine guest wait times.

The computer system can then return information in block 522. Returning information can include storing any of the above mentioned determinations or outputs in a data store. Returning information can include transmitting any of the above mentioned determinations or outputs to other computing systems, such as a computing device of a relevant user (e.g., a team member associated with the retail environment). The returned information can include annotated image data from block 506, the annotations indicating objects that have been identified by the computer system. The returned information can include correlated data information from one or more of the blocks 508, 510, 514, 516, 518, and/or 520. The returned information can include information about the identified objects that do not include team members (in response to performing block 512).

The computer system can optionally perform one or more of blocks 524-536. The blocks 524-536 can be performed for each object that is identified in the received data. In some implementations, the blocks 524-536 can be performed for an aggregate or average of the objects identified in the received data.

For example, the computer system may detect a first change in movement of the identified object(s) proximate the bounding box that satisfies one or more wait criteria (block 524). As described in reference to FIG. 3, the computer system can detect when an identified object, such as a guest or their cart/basket, enters a predetermined zone (e.g., bounding box) that indicates a checkout wait area. Sometimes, the computer system can determine whether the identified object enters and remains with the predetermined zone for at least a threshold amount of time. In other words, a guest may pass through the predetermined zone to continue with their shopping in another area of the retail environment. Because the guest is passing through the predetermined zone, their activity may not indicate someone who is entering the predetermined zone to then perform a checkout process. On the other hand, a guest who enters the predetermined zone and slows down in pace once entering the zone may indicate someone who is entering the zone to proceed to checkout. This guest can satisfy the one or more wait criteria. Refer to FIG. 3 for further discussion.

The computer system can then optionally start a timer based on satisfaction of the one or more wait criteria (block 526). As indicated above, if the computer system identifies that the guest is slowing down in speed/movement upon entering the predetermined zone (such as slowing down in speed by some predetermined amount of time), then the timer can be started. Refer to FIG. 3 for further discussion.

The computer system may then optionally detect a second change in movement of the identified object(s) in block 528. For example, the computer system can detect that the guest is moving through the predetermined zone (such as at a speed that is less than some predetermined speed) and/or approaching or entering another, adjacent zone. This other zone can be a checkout area of the retail environment. If the guest is approaching or entering the checkout area, then the computer system can determine that the guest is no longer waiting to enter the checkout area and perform the checkout process.

Accordingly, the computer system can optionally stop the timer based on detection of the second change in movement in block 530.

The computer system can then optionally determine a wait time of the identified object(s) based on the timer (block 532). A total time that the timer was running/activated can indicate the total wait time for the particular identified object.

The computer system may also generate wait time estimation information based on applying AI modeling techniques to the determined wait time of the identified object(s) in block 534. For example, the computer system can use a machine learning model that was trained with historic data indicating waits, traffic, transaction activity, and other retail environment activity over one or more periods of time. The model can be trained to extrapolate or otherwise predict/project future expected wait times for the retail environment based on the determined wait time of the identified object(s), or an aggregate or average of the determined wait times of the identified objects in the retail environment. Sometimes, the model can be trained to predict future expected wait times based on seasonality (e.g., whether it's a holiday), demand for certain items (e.g., ice cream during the summer), and/or sales or other offers. The model can be iteratively trained to improve its decision making capabilities and accuracy in predicting wait times in the retail environment.

In block 536, the computer system can optionally return the wait time estimation information. As described in relation to block 522, the wait time estimation information (e.g., actual wait time determined in block 532 and/or predicted wait time estimations determined in block 534) can be stored in the data store and available for later retrieval/use. The wait time estimation information can be returned to other computing systems, such as the computing device of a relevant user of the retail environment. The relevant user can view the wait time estimation information in graphical user interface (GUI) displays presented at their respective device. The wait time estimation information can be used by the relevant user to assess busyness and activity in the retail environment and improve operations performed therein to provide improved guest experiences.

In some implementations, the process 500 can be performed in batch processes. For example, blocks 504-536 can be performed at predetermined time intervals and/or after a batch of data has been received in block 502. In some implementations, the process 500 can be performed while or as the computer system receives the data in block 502.

FIG. 6 is a flowchart of a process 600 for estimating guest wait time based on POS and/or register activity data. The process 600 can provide an example of backward correlation of guest activity to POS register activity/volume in order to estimate the guest wait time. The process 600 can be performed using one or more machine learning and/or AI models. Such models can be trained using historic transaction, POS, and/or register data and other retail environment activity data to correlate register activity with guest wait times, similar to other model training described herein. The process 600 can be performed in retail environments that may not have cameras or other imaging devices that could provide image data to be correlated with location data to determine guest wait time. In some implementations, the process 600 can be performed with image data and transaction data, instead of wireless location signaling data. The process 600 can also be performed in retail environments where location and image data are correlated together to determine the guest wait time-the determinations made using POS/register data can validate determinations of guest wait time that were made by correlating the other data using the techniques described herein.

The process 600 can be performed by the computer system 102. The process 600 can also be performed by one or more other computing systems, devices, computers, networks, cloud-based systems, and/or cloud-based services. For illustrative purposes, the process 600 is described from the perspective of a computer system.

Referring to the process 600 in FIG. 6, the computer system can receive POS terminal transaction data in block 602. The transaction data can be received from POS terminals in a checkout area of the retail environment (e.g., self-checkout area, manual checkout area). In some implementations, the transaction data can be transmitted to a data store and then retrieved from the data store by the computer system. The transaction data can be received periodically (e.g., at predetermined time intervals), in batch from multiple POS terminals, and/or continuously as transactions are completed at respective POS terminals. The computer system can sometimes poll the POS terminals in a particular region of the checkout area (such as a region identified using the above techniques where a guest is detected as moving from a wait area to a particular POS terminal to complete a checkout process). The computer system can also poll any of the POS terminals in the checkout area for transaction data.

The transaction data can include transaction times data (block 604), POS terminal throughput data (block 606), and/or transaction details data (block 608). Every transaction performed at a POS terminal can include a time at which the transaction took place (e.g., when the transaction started and/or when the transaction ended). Sometimes the times data can indicate how long the transaction lasted. The throughput data can include indications of how many transactions occurred at the respective POS terminal over one or more periods of time (e.g., over an entire day, over 1 hour, over another predetermined amount of time that can be designated by the POS terminal and/or by the computer system). The transaction details data can include information such as items scanned and purchased (e.g., their respective identifiers, descriptions, quantities), cost of each of the items/all the items, and/or an identifier for the guest making the purchase.

The computer system can retrieve an AI model in block 610. The model can be an ordinary least squares (OLS) regression model, in some implementations. The AI model can be trained similarly to other models described herein. The model can be trained with historic transaction data. Sometimes, once the model is trained, it can be retrained, validated, and/or improved upon using image data, wireless location signals data, correlated data, and/or previous determinations of guest wait time for the retail environment or one or more other retail environments. The model can be trained to determine a relationship between guest wait time and information received from the POS terminals, such as throughput and transaction times. Relationships found in the transaction data can be annotated during training and scaled to the perspective of guest wait time. Only so many guests can use a same POS terminal to complete their checkout processes during some period of time. When that throughout at the POS terminal is capped, the wait time may also be capped. Therefore, the model can be trained to infer the guest wait time based on correlating POS data such as how many POS terminals are open and how many transactions occur at those open POS terminals.

In block 612, the computer system can apply the model to the transaction data. The model can be trained to predict or determine the guest wait time based on a formula such as Log(y)=1.11*log(ρ)+5.47. Register utilization (ρ) (e.g., POS terminal throughput data) can be a predictor of outcome y, which signifies guests waiting time. Variability in such guest wait time can be explained by the register utilization variable (ρ). In an illustrative example, if more than 10 guests are waiting before a checkout area, their wait time can increase by X. In some implementations, the model can be trained to identify a relationship in which increases or decreases in transaction value are correlated against wireless location signals data then translated to wait time. For example, a greater transaction value can indicate that a guest is purchasing more items than a guest with a smaller transaction value. The model can be trained to determine whether the items in transaction data associated with the greater transaction value were identified in wireless location signals data, thereby confirming that the greater transaction value is linked to the guest purchasing many items (rather than the guest purchasing one expensive item). Because the guest was purchasing many items, other guests waiting to checkout after the guest with the many items may experience a longer wait time while the guest with the many items performs their checkout process. Accordingly, the model can be trained to identify and quantify guest wait time based on such transaction data and related factors. In some implementations, the transaction data can be used to bolster an equation and/or algorithm that can be used for estimating the guest wait time. In other words, the transaction data may be taken into account to determine the guest wait time. In some implementations, the model may be trained on the transaction data. In some implementations, the model may not be trained on the transaction data. In yet some implementations, the model can be trained over time to determine additional or other factors.

The computer system can determine, based on applying the AI model, guest wait time estimation information (block 614). The model can output a value indicating the guest wait time that is determined as described above. In some implementations, the computer system can optionally correlate the model output with image data and/or wireless location signals data that is received from devices described throughout this document (block 615). Correlating the model output with the other data can verify or validate the guest wait time information determined by the model. In yet some implementations, correlating the model output with the other data can verify or validate guest wait time information that was determined by the computer system as a result of processing the other data with one or more models described herein.

The computer system can return the guest wait time estimation information in block 616. Refer to blocks 522 and 536 in the process 500 of FIGS. 5A and 5B for further discussion about returning the information.

Optionally, the computer system can provide the information as training input for iteratively improving the AI model in block 618. As described herein, the model output can be fed back into the model to relearn and/or improve model decisions and outcomes. Other information can also be provided as input for training the AI model, including but not limited to the image data, the wireless location signals data, the correlated data, and/or other guest wait time information that may be determined by the computer system using models and/or the correlated data as described above (refer to the process 500 in FIGS. 5A and 5B).

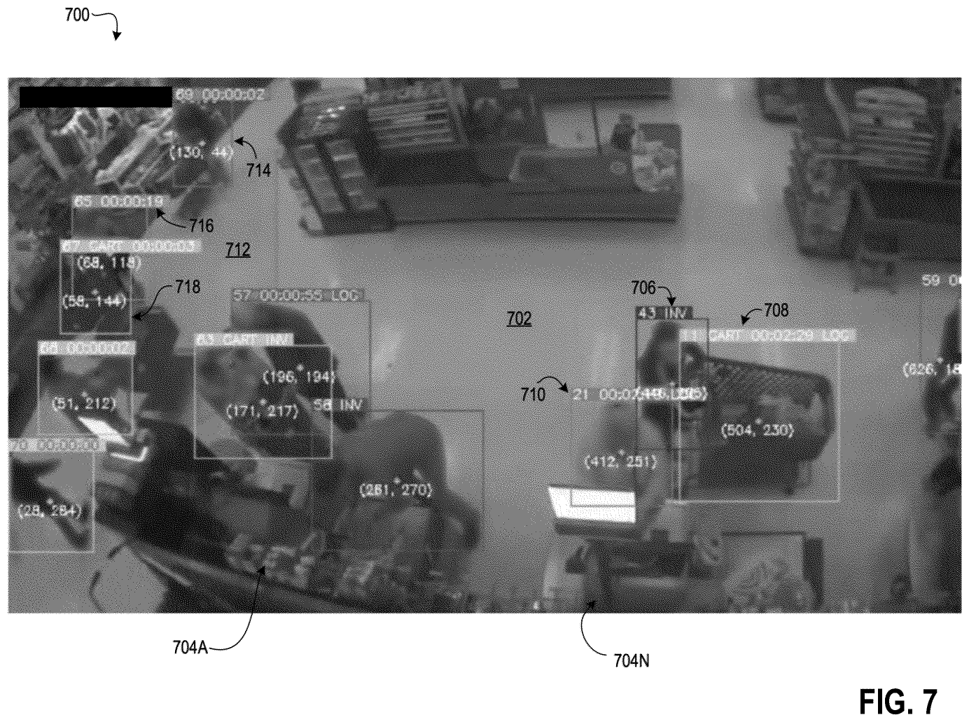

FIG. 7 illustrates example image data 700 that is processed using computer vision techniques described herein to determine guest information near a checkout area 702 of a retail environment. A computer system, as described in this document, receives the image data 700 and process the image data 700 using one or more machine learning and/or AI modeling techniques.

Processing the image data 700 includes translating the image data 700 to a predetermined coordinate plane (e.g., a global coordinate system) to then identify objects therein. The computer system can identify and designate zones in the image data 700 indicative of areas such as the checkout area 702 having POS terminals 704A-N and a wait area 712 proximate the checkout area 702. Here, the computer system may generate a bounding box round the wait area 712. The computer system can also process the image data 700 by identifying objects therein and generating bounding boxes around each of the identified objects. Here, the computer system has identified and generated bounding boxes around, at least, a cart 708 at the POS terminal 704N in the checkout area 702, guests 710 and 706 near the cart 708 in the checkout area 702, a guest 714 entering the wait area 712, a guest 716 standing in the wait area 712, and a cart 718 proximate the guest 716. Other objects (e.g., guests, carts, team members) appear in the image data 700 but are not described in the example of FIG. 7, merely for illustrative purposes.

Using the techniques described herein (refer at least to the process 500 of FIGS. 5A and 5B), the computer system can track movement of the identified objects in the wait area 712, from the wait area 712 to the checkout area 702, and in the checkout area 702 to determined guest wait time information. For example, the computer system may determine that the guest 714 appears to enter the wait area 712, then slow down in movement to stand behind the guest 716, thereby indicating that the guest 714 is getting into line behind the guest 716, waiting to perform a checkout process. The computer system can also determine that the guest 716 has not moved for at least a threshold amount of time, thereby indicating that the guest 716 is waiting in line before proceeding to one of the POS terminals 704A-N that opens up/becomes available. In some implementations, if the computer system determines that the guest 714 enters the wait area 712 but doesn't slow down to stand behind the guest 716 and instead continues to pass through the wait area 712 then move out of sight of the camera, the computer system can discard data associated with the guest 716. In other words, the computer system may not consider the guest 716 in determining guest wait time information in the wait area 712 of the retail environment.

Components and techniques described herein can be configured to a particular retail environment and still allow for accurate determination and/or estimation of guest wait time information. For example, camera angle can be changed in or near the wait area 712 and/or the checkout area 702. Sometimes, the camera angle can be adjusted so that the camera's field of view would include a longest potential line of guests waiting in the wait area 712. Sometimes, the camera can first be angled to encompass an area where a longest potential line of guests may wait before checkout. Then the computer system can define zones (e.g., the wait area 712 and the checkout area 702) based on the camera angle.

The computer system can identify and/or set numerous different zones and/or areas in a retail environment. The computer system may also establish expected wait times per zone in the retail environment. As an illustrative example, the retail environment can have 2 belted checkout lanes (e.g., manual checkout lanes operated by team members), and the computer system can identify a separate zone per lane. The computer system can then measure and/or determine guest wait time information for each lane based on analyzing information associated with the respective zone.

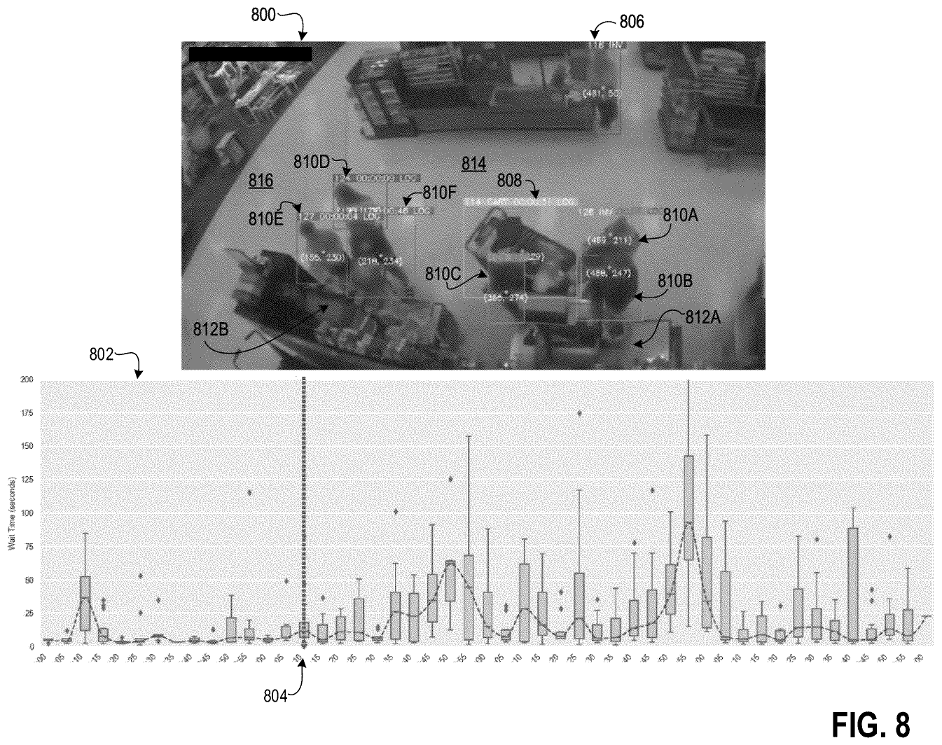

The disclosed techniques are also configurable in that the computer system can determine what guest wait times to use in determining guest wait time information for the retail environment. The computer system may determine the wait time for the guest 714, the guest 716, the cart 718, the guests 706 and/or 710, the cart 708, or any combination thereof. To determine the overall guest wait time for the retail environment, the computer system can use any combination of the above mentioned wait times. For example, the computer system may only use the wait times determined for the guests 714, 716, 706, and/or 710, thereby omitting the wait times linked to those guests carts 718 and/or 708. Sometimes, as described further in reference to FIG. 8, the computer system can group together guests that appear to be together and then determine a wait time for the group of guests. The wait time for the group can be determined by averaging wait times determined for each guest in the group. The wait time for the group can be determined by determining a wait time for only one of the guests in the group (a guest that remains with the cart 708 the entire time, a guest that waits in line in the wait area 712 for the longest amount of time out of all the group members, a guest that performs a checkout process at the POS terminal 704N, etc.). The wait time for the group can be determined, in some implementations, by determining a wait time for an asset, such as the cart 708, associated with the group.

In the example of FIG. 7, the computer system can group together the guests 706 and 710, based on their physical proximity to each other and the cart 708 during one or more threshold periods of time. The guests 706 and 710 may also be grouped together because the computer system determined that the guests 706 and 710 remained within a threshold distance of each other since they both entered the wait area 712 and then as they proceeded to the POS terminal 704N in the checkout area 702.

FIG. 8 illustrates example image data 800 that is processed using the disclosed techniques to determine busyness in a retail environment. Similar to the image data 700 of FIG. 7, the image data 800 can be processed by a computer system described herein. Processing the image data includes identifying a checkout area 814 and a wait area 816 in the retail environment. Here, no line of guests or assets has formed in the wait area 816. Moreover, the wait area 816 includes portions of aisles or other shopping locations in the retail environment, which can further be based on an angle of a camera that captured the image data 800.

Using the techniques described at least in reference to FIG. 7, the computer system can identify and generate bounding boxes around a team member 806, a cart 808, and guests 810A-F at POS terminals 812A-B. Here, the computer system can determine that the guests 810A, 810B, and 810C are together in a group and associated with the cart 808 at the POS terminal 812A. The computer system also can determine that the guests 810D, 810E, and 810F are together in a second group at the POS terminal 812B. Groups of guests (such as the guests 810A, 810B, and 810C) that cross from one zone into another, such as from the wait area 816 into the checkout area 814, can add strength to a bin of data for a particular time period. The added strength can increase accuracy in determining guest wait time for the retail environment.

The computer system can identify the team member 806 as a team member and not a guest based on analyzing behavior, characteristics, and/or attributes of the team member 806 during one or more periods of time. For example, the team member 806 may stand in place for extended periods of time (or perform other expected patterns of behavior for a team member), thereby overseeing activity in the checkout area 814, and perhaps specifically at the POS terminals 812A-B. As another example, the team member 806 may be wearing clothes or a badge that is worn by other team members in the retail environment (and not worn by guests), which the computer system can identify using the disclosed techniques. Because the computer system identifies the team member 806 as a team member and not a guest, the computer system may not use data associated with the team member 806 as part of the guest wait time determination.

The computer system can determine the guest wait time information using the disclosed techniques at predetermined time intervals. The computer system can determine wait time information for each of the guests 810A-F and the cart 808. The computer system can then average the wait times to determine an overall guest wait time for the retail environment at a particular time/interval. As described in reference to FIG. 7, the computer system can determine the wait time for a group of guests or one of the guests in the group, then average all the determined wait times to generate the average wait time for the retail environment. In some implementations, the computer system can determine the average guest wait time in the retail environment on 15 minute intervals. Any other desired period of time or interval can be used.

The computer system may generate visualizations of the average guest wait time in the retail environment, such as a box plot 802. The box plot 802 can indicate, at particular time intervals, guest wait times that were determined by the computer system according to the disclosed techniques. The box plot 802 can further sync up with image data (or wireless location signal data or correlated data) that is processed by the computer system to visually demonstrate the determine guest wait times.

Here, the image data 800 corresponds to bin 804 in the box plot 802. The bin 804 indicates a low guest wait time (measured in seconds) as compared to other times throughout a day or other extended period of time. The box plot 802 may also show a median, at least first and third quartiles, and any outliers. The computer system can further generate an interpolation line over the box plot 802, which can track a median/average wait time. The interpolation line can be correlated with expected wait times in the retail environment and/or in other retail environments. Such information can be used by the computer system to improve the models described herein that may estimate guest wait time over one or more current, past, and/or future periods of time.

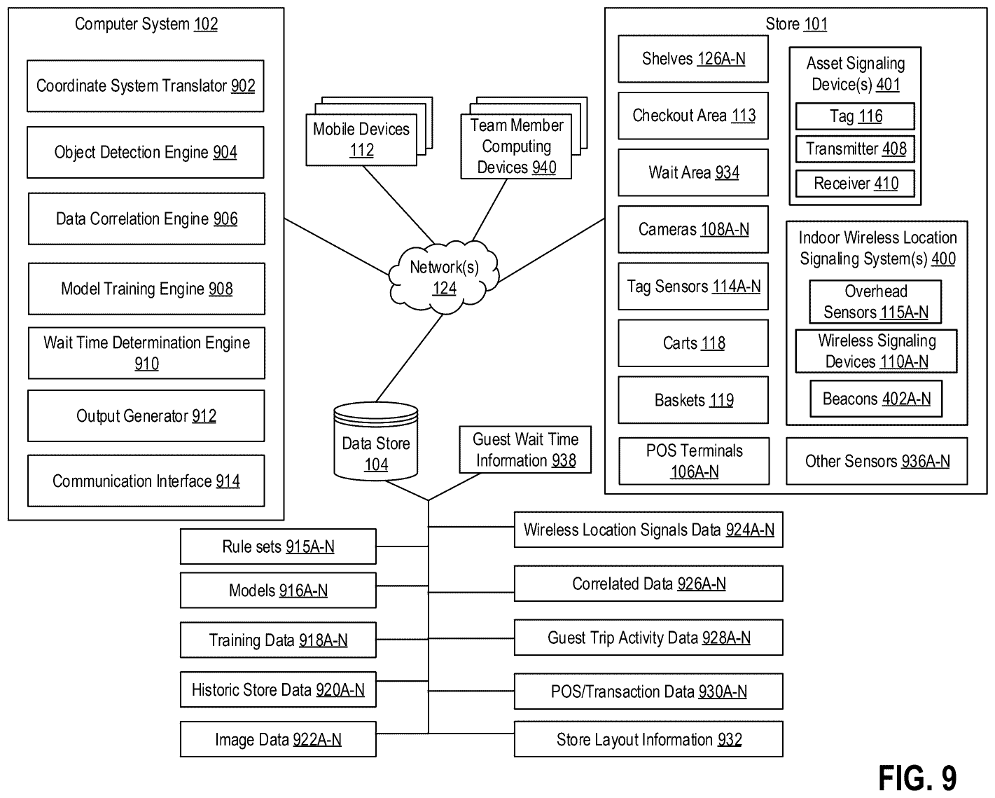

FIG. 9 is a diagram illustrating one or more system components that can be used to perform the disclosed techniques. The computer system 102 can communicate with components in the store 101, the data store 104, and the mobile devices 112 via the network(s) 124. The store 101 can include the shelves 126A-N, the checkout area 113, a wait area 934 (or any of the other wait areas described throughout this disclosure), the cameras 108A-N, the tag sensors 114A-N, the carts 118, the baskets 119, the POS terminals 106A-N, the asset signaling device(s) 402 (each having one or more of the tag(s) 116, the transmitter(s) 408, and/or the receiver(s) 410), the indoor wireless location signaling system(s) 400 (each having one or more of the sensors 115A-N, the wireless signaling devices 110A-N, and/or the beacons 402A-N), and/or other sensors 936A-N(e.g., motion, RFID, laser, light, video, image). Refer to at least FIGS. 1A, 4A, 4B, and 4C for further discussion about the components of the store 101 and other components mentioned above.

The computer system 102 can include a coordinate system translator 902, an object detection engine 904, a data correlation engine 906, a model training engine 908, a wait time determination engine 910, an output generator 912, and/or a communication interface 914. The communication interface 914 can allow for communication between components of the computer system and the other system components described herein via the network(s) 124.

The coordinate system translator 902 can be configured to translate one or more of image data 922A-N and/or wireless location signals data 924A-N into a desired coordinate system. The data 922A-N and 924A-N can be received directly from devices in the store 101. The data 922A-N and 924A-N can also be retrieved from the data store 104 by the translator 904. Refer to at least FIGS. 1A, 1B, 2A, 2B, 2C, and 5A for further discussion about translating the data via the translator 904 of the computer system 102.

The object detection engine 904 can be configured to employ one or more models 916A-N and/or rule sets 915A-N to identify objects and/or zones/areas in the translated image data 922A-N and/or wireless location signals data 924A-N. The models 916A-N and/or the rule sets 915A-N can be retrieved by the engine 904 from the data store 104. In some implementations, one or more of the models 916A-N and/or the rule sets 915A-N can be stored locally at the computer system 102 and quickly/easily retrieved by the engine 904 for runtime use. The engine 904 can also retrieve store layout information 932 from the data store 104 to be used in identifying and designating objects and zones in the translated data. The engine 904 can also be configured to draw bounding boxes around the identified objects in the data 922A-N and/or 924A-N and track the bounding boxes across the data to determine information about the store 101, such as guest wait time. Refer to at least FIGS. 1A, 1C, 2A, 2B, 2C, 4B, 5A, 7, and 8 for further discussion about detecting the objects in the data 922A-N and/or 924A-N.

The data correlation engine 906 can be configured to correlate and/or combine one or more of the image data 922A-N, the wireless location signals data 924A-N, and/or POS/transaction data 930A-N. Any of the data 922A-N, 924A-N, and/or 930A-N can be received from components in the store 101 and/or retrieved from the data store 104. In some implementations, the engine 906 can retrieve guest trip activity data 928A-N from the data store 104, which can be correlated with other retrieved or received data. Correlations of data that the engine 906 make can be stored in the data store 104 as correlated data 926A-N. Refer to at least FIGS. 1A, 1B, 2A, 2B, 2C, 3, 5A, and 6 for further discussion about correlating or combining data.

The model training engine 908 can be configured to train and retrain (iteratively improve) any of the models 916A-N described herein. The engine 908 can retrieve training data 918A-N, historic store data 920A-N, guest wait time information 938, or other data from the data store 104 for training the models 916A-N. Refer to at least FIGS. 1A, 1B, 1C, 2A, 2B, 2C, 3, 4B, 5A, 5B, and 6 for further discussion about training, retraining, and using the models 916A-N.

The wait time determination engine 910 can be configured to determine guest wait time information 938, such as a wait time for each of the identified objects in the data from the object detection engine 904 and/or the data correlation engine 906. The engine 910 can be configured to determine a wait time for only some of the identified objects (e.g., a group of guests shopping together, a guest but not their respective shopping cart or basket). The engine 910 can also be configured to determine an aggregate or average wait time for the store 101, which can be based on a combination of the individual wait times determined by the engine 910 for one or more of the identified objects. The engine 910 can also project or otherwise predict one or more future guest wait times for the store 101 and/or for other stores or retail environments. In some implementations, the engine 910 can determine the guest wait time information 938 using the POS/transaction data 930A-N. Refer to at least FIGS. 1A, 2A, 2B, 2C, 3, 5A, 5B, 6, and 8 for further discussion about determining the guest wait time information 938.

The output generator 912 can be configured to generate output about the determined guest wait time information 938. The output can include graphics or other visual representations of the determined guest wait time information 938, as shown in the example of FIG. 8. In some implementations, the generator 912 can also generate output such as the guest trip activity data 928A-N and/or a map of guest trip activity according to the store layout information 932. Various other outputs can also be generated, stored in the data store 104, and/or transmitted to relevant computing devices, such as team member computing devices 940. The team member computing devices 940 can be similar to the mobile devices 112 described throughout this disclosure.

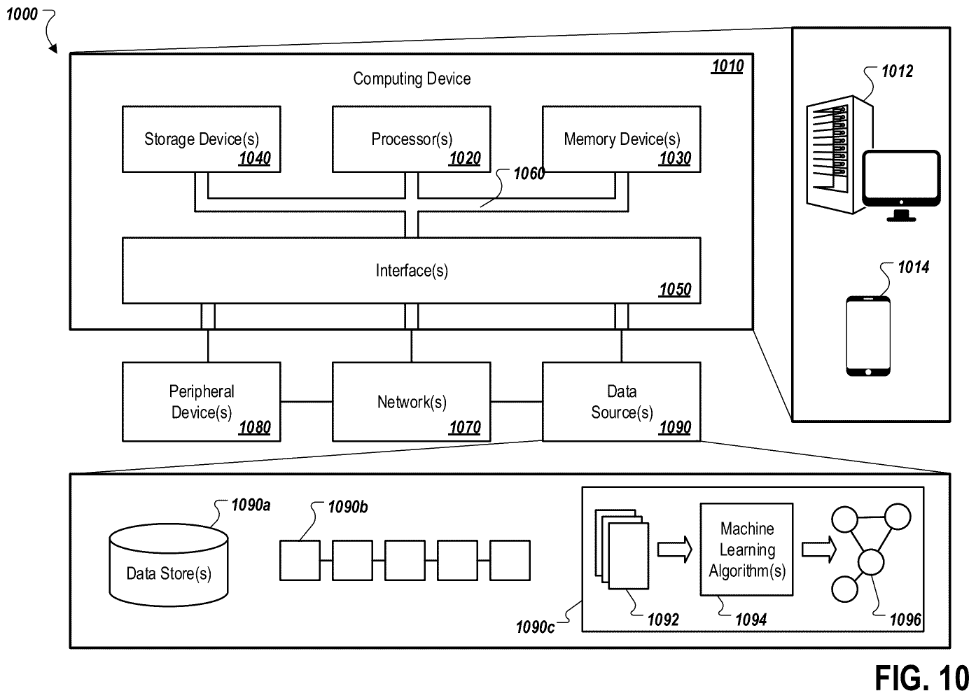

FIG. 10 is a schematic diagram that shows an example of a computing system 1000 that can be used to implement the techniques described herein. The computing system 1000 includes one or more computing devices (e.g., computing device 1010), which can be in wired and/or wireless communication with various peripheral device(s) 1080, data source(s) 1090, and/or other computing devices (e.g., over network(s) 1070). The computing device 1010 can represent various forms of stationary computers 1012 (e.g., workstations, kiosks, servers, mainframes, edge computing devices, quantum computers, etc.) and mobile computers 1014 (e.g., laptops, tablets, mobile phones, personal digital assistants, wearable devices, etc.). In some implementations, the computing device 1010 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 1010, and an entire system can be made up of multiple devices communicating with each other. For example, the computing device 1010 can be part of a computing system that includes a network of computing devices, such as a cloud-based computing system, a computing system in an internal network, or a computing system in another sort of shared network. Processors of the computing device (1010) and other computing devices of a computing system can be optimized for different types of operations, secure computing tasks, etc. The components shown herein, and their functions, are meant to be examples, and are not meant to limit implementations of the technology described and/or claimed in this document.

The computing device 1010 includes processor(s) 1020, memory device(s) 1030, storage device(s) 1040, and interface(s) 1050. Each of the processor(s) 1020, the memory device(s) 1030, the storage device(s) 1040, and the interface(s) 1050 are interconnected using a system bus 1060. The processor(s) 1020 are capable of processing instructions for execution within the computing device 1010, and can include one or more single-threaded and/or multi-threaded processors. The processor(s) 1020 are capable of processing instructions stored in the memory device(s) 1030 and/or on the storage device(s) 1040. The memory device(s) 1030 can store data within the computing device 1010, and can include one or more computer-readable media, volatile memory units, and/or non-volatile memory units. The storage device(s) 1040 can provide mass storage for the computing device 1010, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 1050 can include various communications interfaces (e.g., USB, Near-Field Communication (NFC), Bluetooth, WiFi, Ethernet, wireless Ethernet, etc.) that can be coupled to the network(s) 1070, peripheral device(s) 1080, and/or data source(s) 1090 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 1050 can include a control interface that receives commands from an input device (e.g., operated by a user) and converts the commands for submission to the processors 1020. The interface(s) 1050 can include a display interface that includes circuitry for driving a display to present visual information to a user. The interface(s) 1050 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 1070 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 1010 can communicate with the peripheral device(s) 1080, the data source(s) 1090, and/or other computing devices over the network(s) 1070. In some implementations, the computing device 1010 can directly communicate with the peripheral device(s) 1080, the data source(s), and/or other computing devices.

The peripheral device(s) 1080 can provide input/output operations for the computing device 1010. Input devices (e.g., keyboards, pointing devices, touchscreens, microphones, cameras, scanners, sensors, etc.) can provide input to the computing device 1010 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 1010 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 1090 can provide data for use by the computing device 1010, and/or can maintain data that has been generated by the computing device 1010 and/or other devices (e.g., data collected from sensor devices, data aggregated from various different data repositories, etc.). In some implementations, one or more data sources can be hosted by the computing device 1010 (e.g., using the storage device(s) 1040). In some implementations, one or more data sources can be hosted by a different computing device. Data can be provided by the data source(s) 1090 in response to a request for data from the computing device 1010 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 1090a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 1090b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 1090c. The machine learning system(s) 1090c, for example, can be used to analyze data from various sources (e.g., data provided by the computing device 1010, data from the data store(s) 1090a, data from the blockchain(s) 1090b, and/or data from other data sources), to identify patterns in the data, and to draw inferences from the data patterns. In general, training data 1092 can be provided to one or more machine learning algorithms 1094, and the machine learning algorithm(s) can generate a machine learning model 1096. Execution of the machine learning algorithm(s) can be performed by the computing device 1010, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A system for determining a wait time of objects in a designated area of a physical space, the system comprising:
cameras positioned proximate the designated area and configured to capture image data of the designated area;
location signaling devices configured to capture wireless signals indicating locations of the objects throughout the physical space, the locations being provided as location data; and
a computer system in wireless network communication with the cameras and the location signaling devices, wherein the computer system is configured to perform operations comprising:
receiving the image data and the location data from the cameras and the location signaling devices, respectively;
translating the received image data into a predetermined coordinate plane;
retrieving one or more artificial intelligence (AI) models from a data store;
identifying the objects within the designated area based on applying the AI models to at least the translated image data;
correlating the identified objects with the received location data;
determining wait time information of the identified objects in the designated area based on applying the AI models to at least the correlated data; and
returning the wait time information.

2. The system of claim 1, wherein the predetermined coordinate plane is a coordinate plane of the location data.

3. The system of claim 1, wherein correlating the identified objects with the received location data comprises verifying that the identified objects are located within the designated area before moving to a second designated area proximate the designated area.

4. The system of claim 1, wherein determining wait time information in the designated area comprises generating a count of the identified objects that form a line in the designated space.

5. The system of claim 1, wherein determining wait time information in the designated area based on applying the AI models to at least the correlated data comprises:
determining that an object amongst the identified objects enters the designated area;
detecting a decrease in movement of the object in the designated area;
starting a timer in response to detecting the decrease in movement;
determining that the object enters a second designated area proximate the designated area;
stopping the timer in response to determining that the object enters the second designated area; and
determining a wait time of the object as a total time that the timer was activated.

6. The system of claim 5, wherein the AI models were trained to perform the determining, the detecting, the starting, the determining, the stopping, and the determination operations.

7. The system of claim 5, wherein the AI models were trained to perform the determining the wait time of the object operation.

8. The system of claim 1, wherein determining wait time information in the designated area comprises:
determining a wait time for each of the identified objects based on applying the AI models to at least the correlated data; and
determining an average wait time for the identified objects based on combining the wait time for each of the identified objects.

9. The system of claim 1, wherein identifying the objects within the designated area comprises:
identifying one or more objects that are within a threshold proximity of each other in the designated area; and
grouping the identified one or more objects into a group, wherein determining wait time information in the designated area comprises determining a wait time for the group.

10. The system of claim 1, wherein the operations further comprise:
receiving transaction data from one or more point of sale (POS) terminals that are proximate the designated area; and
correlating, based on applying the AI models, at least one of the image data or the location data with the transaction data to determine the wait time information.

11. The system of claim 1, wherein identifying the objects within the designated area based on applying the AI models to at least the translated image data further comprises:
detecting one or more of the objects that satisfy one or more object behavior; and
removing the detected objects from the translated image data.

12. The system of claim 1, wherein the operations further comprise:
correlating portions of the translated image data with the received location data that satisfy one or more proximity criteria; and
identifying the objects within the designated area based on applying the AI models to the correlated data.

13. The system of claim 1, wherein the identified objects comprise assets, each of the assets comprising an asset signaling device, wherein the asset signaling device is configured to transmit and receive signals with at least the location signaling devices, wherein the location signaling devices are configured to generate the location data based on the transmitted and received signals with the asset signaling device.

14. The system of claim 1, wherein returning the wait time information comprises presenting the wait time information in a graphical user interface (GUI) display of a user relevant to the physical space.

15. The system of claim 1, wherein the wait time information is determined, by the computer system, for a predetermined future period of time.

16. The system of claim 1, wherein the AI models comprise an ordinary least squares (OLS) model.

17. The system of claim 1, wherein determining wait time information further comprises generating a graphical depiction of the wait time information that is synced with the translated image data.

18. The system of claim 1, wherein the designated area is a wait area before a checkout area in a retail environment.

19. A method for determining a wait time of objects in a designated area of a physical space, the method comprising:
receiving, by a computer system, (i) image data from cameras positioned proximate the designated area that are configured to capture the image data of the designated area and (ii) location data from location signaling devices that are configured to capture wireless signals indicating locations of the objects in the physical space, the locations being provided as the location data;
translating, by the computer system, the received image data into a predetermined coordinate plane;
retrieving, by the computer system, one or more artificial intelligence (AI) models from a data store;
identifying, by the computer system, the objects within the designated area based on applying the AI models to at least the translated image data;
correlating, by the computer system, the identified objects with the received location data;
determining, by the computer system, wait time information of the identified objects in the designated area based on applying the AI models to at least the correlated data; and
returning, by the computer system, the wait time information.

20. The method of claim 19, wherein determining, by the computer system, wait time information in the designated area comprises:
determining that an object amongst the identified objects enters the designated area;
detecting a decrease in movement of the object in the designated area;
starting a timer in response to detecting the decrease in movement;
determining that the object enters a second designated area proximate the designated area;
stopping the timer in response to determining that the object enters the second designated area; and
determining a wait time of the object as a total time that the timer was activated.
